(19) United States
(12) Patent Application Publication
(10) Pub. No.: US 2025/0289248 A1
(43) Pub. Date: Sep. 18, 2025

(54) PRINTER CUTTER SYSTEM AND METHOD

(71) Applicant: Brady Worldwide, Inc., Milwaukee, WI (US)

(72) Inventors: Bradley Strandberg, Waukesha, WI (US); Brent A. Bandholz, Hubertus, WI (US)

(21) Appl. No.: 18/602,316

(22) Filed: Mar. 12, 2024

(51) Int. Cl. B41J 11/70

(52) U.S. Cl. CPC B41J 11/706

(57) ABSTRACT

A cutter assembly including one or more of a blade subassembly, a pulley subassembly, and a clamping subassembly is provided. The blade subassembly may include a carriage retaining a blade configured for translational motion along a guiderail. The carriage may be coupled to a belt of the pulley subassembly, and one or more pulleys supported by the frame may be configured to drive linear motion of the belt, thereby generating translational motion of the carriage. In some instances, a motor connected to a gear train may be operably coupled to the one or more pulleys and the belt. In some instances, a clamp of the clamping subassembly is provided to be releasably engaged by the carriage. One or more spring members acting on the clamp may cause the clamp to initiate an automatic cleaning action of the blade when the clamp is engaged by the carriage.

### CROSS-REFERENCE TO RELATED APPLICATIONS

None.

### BACKGROUND

Various classes of printers are commonly equipped with a cutter mechanism designed and positioned to sever individual portions of a continuous supply of printable media before the printed product is retrieved by a user. For example, a printer designed to print adhesive labels may receive a continuous supply of labels (e.g., a plurality of adhesive labels disposed along a continuous strip of liner material), print the desired text or graphic on each label, and then sever the supply of labels one-by-one as they exit the printer such that the label may be conveniently retrieved by a user.

In some cases, particularly in the context of high-volume printing environments (e.g., printing product labels in a commercial context), these cutting mechanisms may be prone to degradation or impaired operation due to repetitive use. In the example mentioned above, the adhesive agent applied to the supply of adhesive labels may accumulate on the blade of the cutter mechanism over time. Similar problems may arise in other contexts as well. For example, certain classes of printable media (e.g., magnets) may cause metal particles or other undesirable particulate matter to accumulate on the blade.

Over time, material buildup on the blade hinders the quality of the cuts performed by the cutter mechanism. If left unattended, such buildup may even shorten the lifespan of the cutter mechanism or the printer in which it is installed. In order to maintain cut quality and avoid damage to or malfunctioning of the cutter mechanism, consumers may be required to perform maintenance on the blade or other components of the cutter mechanism, thereby leading to increased costs and inconvenience. Therefore, a need exists for a cutter mechanism that eliminates the ability of undesirable materials (e.g., adhesive agents, metals, and the like) to accumulate on the blade over time as a result of repetitive use. In particular, a need exists for a cutter mechanism that reduces buildup on the blade as compared to existing solutions and is capable of automatically removing or cleaning material that accumulates on the blade without requiring maintenance.

### SUMMARY

The present disclosure is directed to a cutter assembly for use in a printer.

A cutter assembly for use in a printer is disclosed. The cutter assembly includes a carriage configured for translational movement along a guiderail having a first and second end, a blade retained within the carriage, a breaker bar extending along a path of motion of the blade, a belt engaging at least a portion of the carriage, one or more pulleys configured to generate linear motion of the belt, and a clamp positioned to engage the carriage at one or both of the first end and the second end. Engagement between the clamp and the carriage causes an automatic cleaning action of the blade.

In some aspects, the cutter assembly further includes one or more gears configured to drive rotation of at least one of the one or more pulleys and a motor configured to drive rotation of at least one of the one or more gears.

In some aspects, the clamp further includes one or more deflection tabs arranged to be engaged by the carriage at one or both of the first end and the second end.

In some aspects, engagement between the carriage and at least one of the deflection tabs causes an upward motion of the clamp and releases a supply of printable media.

In some aspects, engagement between the carriage and at least one of the deflection tabs causes the blade to deposit material buildup on the breaker bar.

In some aspects, the breaker bar includes a beveled edge arranged to contact the blade. The beveled edge is defined by an angle of between about 75° and about 80°.

In some aspects, a single point of contact exists between the beveled edge and the blade.

In some aspects, the cutter assembly further includes a belt tensioner coupled to at least one of the pulleys and configured to provide tension to the belt.

In some aspects, a first switch and a second switch are configured to terminate motion of the carriage and are positioned proximate to each of the first end and the second end, respectively.

In some aspects, the clamp further includes a friction member configured to restrict the movement of the printable media when the carriage is in motion.

A cutter assembly for use in a printer is disclosed. The cutter assembly includes a frame supporting a blade subassembly, a pulley subassembly, and a clamping subassembly. The blade subassembly includes a carriage arranged for translational motion across the frame and a blade retained within the carriage. The pulley subassembly is configured to generate translational motion of the blade subassembly and further includes one or more gears, one or more pulleys connected to the one or more gears, and a belt engaging at least one or more of the pulleys and arranged to move linearly about the one or more pulleys. The clamping subassembly is configured to be engaged by the blade subassembly and further includes a brace fixedly coupled to the frame, a clamp flexibly coupled to the brace, and one or more spring members configured to apply a downward pressure on the clamp.

In some aspects, the pulley subassembly includes five pulleys.

In some aspects, the cutter assembly further includes a breaker bar extending along a path of motion of the blade.

In some aspects, the breaker bar is not magnetic.

In some aspects, the blade includes a cutting edge defined by an angle of between about 40° and about 50°.

In some aspects, the cutter assembly further includes a motor engaging at least one of the one or more gears and configured to drive movement of the belt.

In some aspects, the cutter assembly further includes at least one switch arranged to be engaged by the blade subassembly. The at least one switch is configured to deactivate the motor when engaged by the blade subassembly.

In some aspects, the clamp is configured to release a portion of the printable media when the blade subassembly engages the clamping subassembly.

In some aspects, engagement between the gear subassembly and the clamping subassembly causes an automatic cleaning action of the blade.

A method of cutting a supply of media within a printer is disclosed. The method involves feeding the supply of media through a mouth of a frame such that a desired portion of the supply of media extends beyond a breaker bar coupled to the frame. The frame supports a blade subassembly occupying a default position and including a carriage and a blade retained by the carriage, a pulley subassembly including a belt coupled to the carriage and configured for linear movement about one or more pulleys, and a clamping subassembly configured to be releasably engaged by the carriage. The method further involves generating linear motion of the belt such that the carriage moves across the frame and the blade severs the supply of media along an edge of the breaker bar. The method further includes retracting the supply of media away from the mouth. The method further includes returning the blade subassembly to the default position. The clamping subassembly comprises a clamp configured to be engaged by the carriage and to cause an automatic cleaning action of the blade in response to engagement with the carriage.

### BRIEF DESCRIPTION OF THE DRAWINGS

FIG. 1 illustrates an isometric view of a first exemplary printer;

FIG. 2 illustrates a rear elevational view of the printer of FIG. 1;

FIG. 3 illustrates an isometric view of the printer of FIG. 1 in an open configuration;

FIG. 4 illustrates an isometric view of a second exemplary printer;

FIG. 5 illustrates an isometric view of the printer of FIG. 4 in transition between a closed configuration and an open configuration;

FIG. 6 illustrates a top isometric view of the printer of FIG. 4 in a fully open configuration;

FIG. 7 illustrates an isometric view of a third exemplary printer;

FIG. 8 illustrates a rear elevational view of the printer of FIG. 7;

FIG. 9 illustrates an isometric view of the printer of FIG. 7 in an open configuration;

FIG. 10 illustrates a front isometric view of a cutter assembly for use with one or more of the printers of FIGS. 1-9 constructed according to the teachings of the present disclosure;

FIG. 11 illustrates a front isometric view of a frame of the cutter assembly of FIG. 10;

FIG. 12 illustrates a bottom isometric view of a blade subassembly of the cutter assembly of FIG. 10;

FIG. 13 illustrates a side elevational view of the blade subassembly of FIG. 12;

FIG. 14 illustrates a front isometric view of a carrier of the blade subassembly of FIG. 12;

FIG. 15 illustrates a rear isometric view of the carrier of FIG. 14;

FIG. 16 illustrates a front isometric view of a cover of the blade subassembly of FIG. 12;

FIG. 17 illustrates a rear isometric view of the cover of FIG. 16;

FIG. 18 illustrates an isometric view of a blade of the blade subassembly of FIG. 12;

FIG. 19 illustrates a side isometric view of a portion of the blade subassembly of FIG. 12;

FIG. 20 illustrates a side isometric view of a screw member of the blade subassembly of FIG. 12;

FIG. 21 illustrates a side isometric view of a nut member of the blade subassembly of FIG. 12;

FIG. 22 illustrates a side elevational view of a hub of the blade subassembly of FIG. 12;

FIG. 23 illustrates an exploded view of the blade of FIG. 18 installed on the hub of FIG. 22;

FIG. 24 illustrates a rear isometric view of a portion of the blade subassembly of FIG. 12;

FIG. 25 illustrates a bottom isometric view of a portion of the blade subassembly of FIG. 12;

FIG. 26 illustrates a front elevational view of a guiderail of the cutter assembly of FIG. 10;

FIG. 27 illustrates a side isometric view of the guiderail of FIG. 26;

FIG. 28 illustrates a side elevational view of the blade subassembly of FIG. 12 positioned on the guiderail of FIG. 26;

FIG. 29 illustrates an isometric view of the blade subassembly of FIG. 12 positioned on the guiderail of FIG. 26;

FIG. 30 illustrates a front elevational view of the guiderail of FIG. 26 installed on the frame of FIG. 11;

FIG. 31 illustrates a rear isometric view of the blade subassembly of FIG. 12 and the guiderail of FIG. 26 installed on the frame of FIG. 11;

FIG. 32 illustrates a side elevational view of the blade subassembly of FIG. 12 and the guiderail of FIG. 26 installed on the frame of FIG. 11;

FIG. 33 illustrates a front isometric view of a support rail of the cutter assembly of FIG. 10;

FIG. 34 illustrates a front and side isometric view of a breaker bar of the cutter assembly of FIG. 10;

FIG. 35 illustrates a front and side isometric view of the blade subassembly of FIG. 12, the guiderail of FIG. 26, the support rail of FIG. 33, and the breaker bar of FIG. 34 installed on the frame of FIG. 11;

FIG. 36 illustrates a top plan view of the blade of FIG. 18 and a portion of the breaker bar of FIG. 34;

FIG. 37 illustrates an enlarged schematic view of a portion of the cutter assembly of FIG. 10;

FIG. 38 illustrates a front elevational view of a pulley subassembly of the cutter assembly of FIG. 10;

FIG. 39 illustrates a side isometric view of a pulley of the pulley subassembly of FIG. 38;

FIG. 40 illustrates a side isometric view of a compound gear of the pulley subassembly of FIG. 38;

FIG. 41 illustrates a side isometric view of a first pin of the pulley subassembly of FIG. 38;

FIG. 42 illustrates a top plan view of a washer of the pulley subassembly of FIG. 38;

FIG. 43 illustrates a side isometric view of a second pin of the pulley subassembly of FIG. 38;

FIG. 44 illustrates a front isometric view of a belt tensioner of the pulley subassembly of FIG. 38;

FIG. 45 illustrates an enlarged isometric view of a portion of a belt of the pulley subassembly of FIG. 38;

FIG. 46 illustrates a front and side isometric view of a motor of the cutter assembly of FIG. 10;

FIG. 47 illustrates a front isometric view of a driving gear of the pulley subassembly of FIG. 38;

FIG. 48 illustrates a rear isometric view of the pulley subassembly of FIG. 38 and the motor of FIG. 46;

FIG. 49 illustrates a front elevational view of the pulley subassembly of FIG. 38 installed on the frame of FIG. 11;

FIG. 50 illustrates a bottom isometric view of a clamping subassembly of the cutter assembly of FIG. 10;

FIG. 51 illustrates a front isometric view of a clamp of the clamping subassembly of FIG. 50;

FIG. 52 illustrates a bottom isometric view of the clamp of FIG. 51;

FIG. 53 illustrates a front isometric view of a brace of the clamping subassembly of FIG. 50;

FIG. 54 illustrates an isometric view of a shaft and spring members of the clamping subassembly of FIG. 50;

FIG. 55 illustrates a rear isometric view of the clamping subassembly of FIG. 50;

FIG. 56 illustrates an enlarged rear isometric view of a portion of the clamping subassembly of FIG. 50;

FIG. 57 illustrates a rear isometric view of the guiderail of FIG. 26, the breaker bar of FIG. 34, and the clamping subassembly of FIG. 50 installed on the frame of FIG. 11;

FIG. 58A illustrates a top plan view of the cutter assembly of FIG. 10 after a first stage of operation;

FIG. 58B illustrates a front isometric view of the cutter assembly of FIG. 10 after the first stage of operation; and

FIG. 58C illustrates a front isometric view of the cutter assembly of FIG. 10 after a second stage of operation.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments, and of being practiced, or of being carried out, in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the disclosure.

Additionally, while the following discussion may describe features associated with specific devices or embodiments, it is understood that additional devices and/or features can be used with the described systems and methods, and that the discussed devices and features are used to provide examples of possible embodiments, without being limited.

The present disclosure is directed to a cutter assembly designed to cut a desired portion of a supply of printable media, for example, before the desired portion is retrieved by a user. The cutter assembly may be used with a variety of classes of printers. For example, the cutter assembly may be used with one or more of an inkjet printer, a thermal printer, a laser printer, or any other suitable device capable of printing text, images, or other graphics onto printable media.

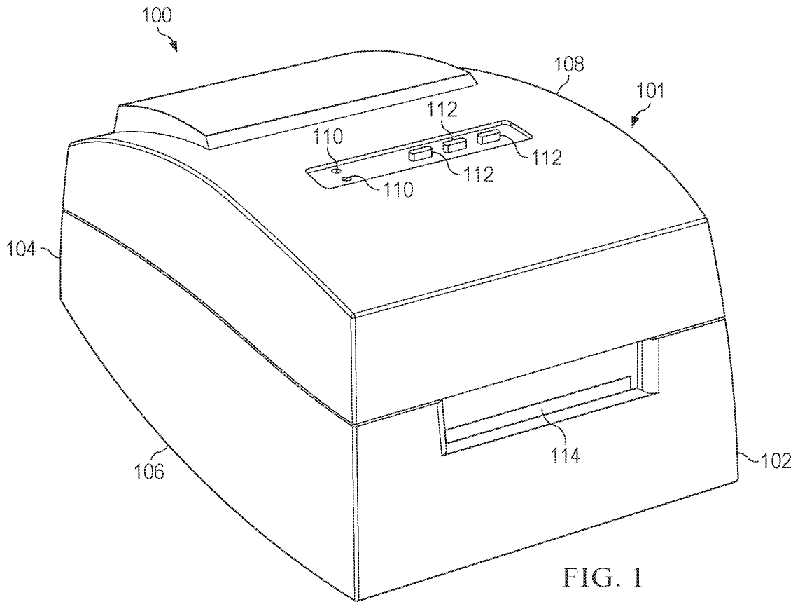

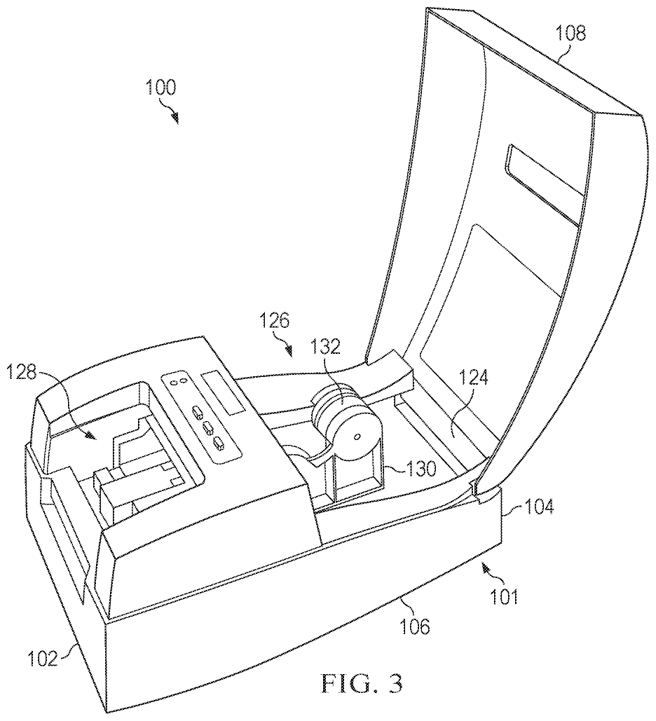

Referring first to FIGS. 1-3, an exemplary inkjet printer 100 is provided in the form of a housing 101 defining a first end 102 (e.g., at a front of the printer) and a second end 104 opposing the first end 102 (e.g., at a rear of the printer). The housing 101 of the inkjet printer 100 is defined by a base portion 106 and an enclosure cover 108. The base portion 106 and the enclosure cover 108 may be hingedly attached or otherwise coupled to one another such that the enclosure cover 108 may be removably opened and/or attached to allow access to the internal components of the inkjet printer 100 and to allow for installation or maintenance of the internal parts. The enclosure cover 108 may be coupled to the base portion 106 via a hinge 124 (see FIG. 3) or other attachment means.

The inkjet printer 100 may include one or more indicators 110 and one or more buttons 112 disposed on the enclosure cover 108. As shown in FIG. 1, the inkjet printer 100 includes two indicators 110 and three buttons 112. However, the inkjet printer 100 may include any number of indicators 110 and/or buttons 112. The indicators 110 may be arranged to alert a user to various conditions of operation of the inkjet printer 100. In some instances, an indicator 110 may be provided in the form of a light emitting diode (LED) configured to indicate to a user when the inkjet printer 100 is powered on or when the inkjet printer 100 is low on ink. Alternatively, the indicators 110 can serve any other suitable purpose. The buttons 112 may be arranged to allow a user to operate, service, or otherwise interface with the inkjet printer 100. For example, a button 112 may be configured to allow a user to load the inkjet printer 100 with new printable media. In some forms, depressing or otherwise actuating the button 112 will cause the enclosure cover 108 to disengage from the base portion 106.

The inkjet printer 100 may include a rectilinear exit slot 114 positioned on and extending through the base portion 106. For example, the exit slot 114 may be provided in the form of a “mouth” or opening disposed on the base portion 106 at the first end 102. Media that has been printed on by the inkjet printer 100 may exit the inkjet printer 100 at the exit slot 114 where it may be retrieved by a user.

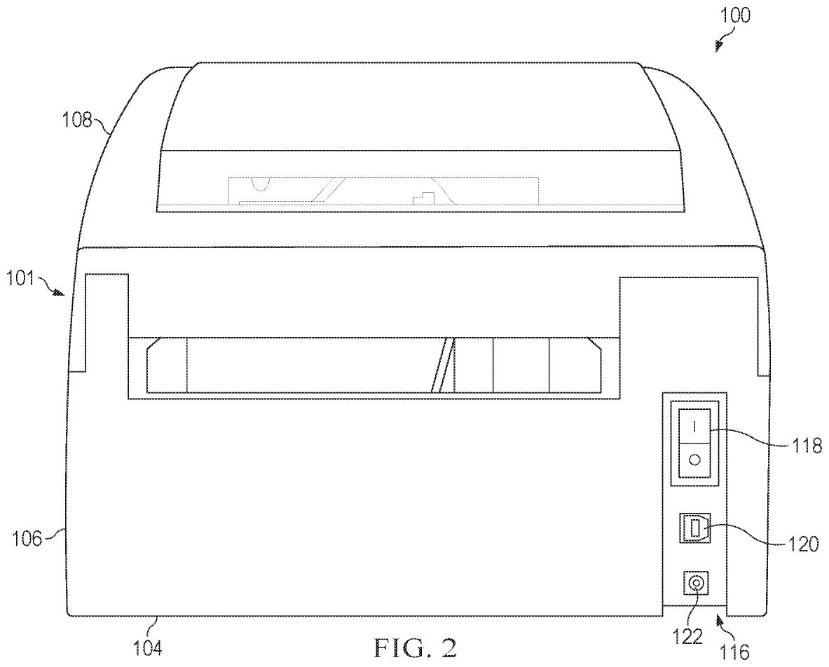

Turning to FIG. 2, the inkjet printer 100 may further include a control region 116 disposed on the base portion 106. For example, the control region 116 may be positioned on the base portion 106 at the second end 104 and may include a power switch 118, an input port 120, and a power port 122. The power port 122 may facilitate coupling between the inkjet printer 100 and an external power source such that a user may power on the inkjet printer 100 using the power switch 118. The input port 120 may facilitate coupling or communication between the inkjet printer 100 and an external device (e.g., a smartphone, desktop computer, digital camera, etc.).

As shown in FIG. 3, the enclosure cover 108 of the inkjet printer 100 is designed to rotate into an open configuration. The enclosure cover 108 may be rotatable about an axis of connection formed by the hinge 124. Thus, a user may place the inkjet printer 100 in the open configuration by lifting the enclosure cover 108 away from the base portion 106 and causing it to rotate about the hinge 124.

The base portion 106 may include a media region 126 proximate to the first end 102 and a printing region 128 proximate to the second end 104. The media region 126 may include a mount 130 capable of supporting media 132 (e.g., a roll of printable labels) for printing. The printing region 128 may include one or more of a printhead (not shown), ink cartridges (not shown), electronic circuitry or controls (not shown), a waste area (not shown), or any other element or mechanism that facilitates printing images, text, or other graphics on the media 132.

Although a specific exemplary inkjet printer 100 is described, it should be appreciated that the inkjet printer 100 for use with the printer cutter mechanism disclosed herein may include or omit additional components as known in the art.

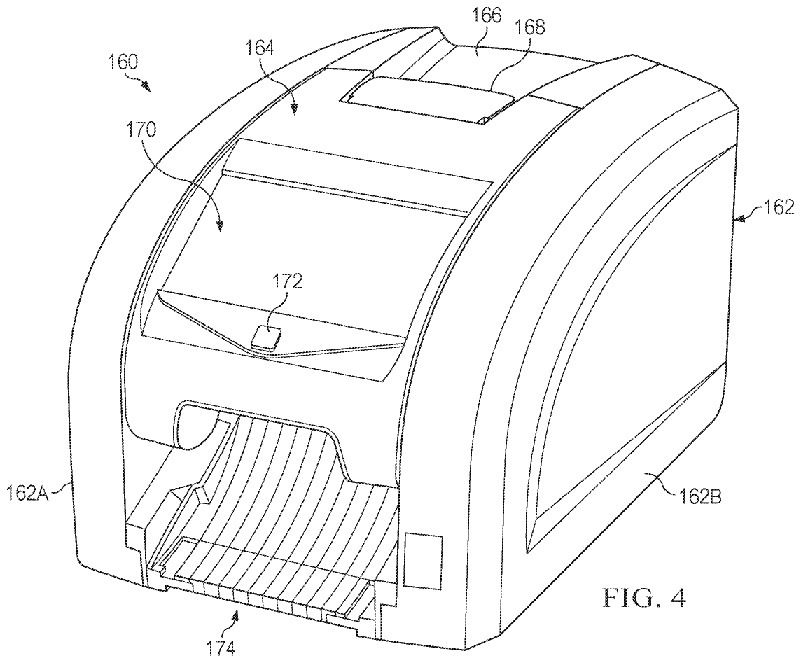

Referring now to FIGS. 4-6, an exemplary thermal printer 160 for use with the printer cutting mechanism herein is depicted. The thermal printer 160 may be provided in the form of a direct thermal printer, a thermal transfer printer, a handheld thermal printer, or any other comparable device. The thermal printer 160 includes a body 162 defined by a first body portion 162A and a second body portion 162B opposing the first body portion 162A. The thermal printer 160 may include a first cover panel 164 and a second cover panel 166. The first and second body portions 162A, 162B together with the first and second cover panels 164, 166 may define an enclosure that retains the internal components of the thermal printer 160. The first cover panel 164 may include one or more of a release latch 168, a display 170, and a power button 172. The thermal printer 160 may include an output region 174 disposed beneath the first cover panel 164 and extending between the first body portion 162A and the second body portion 162B.

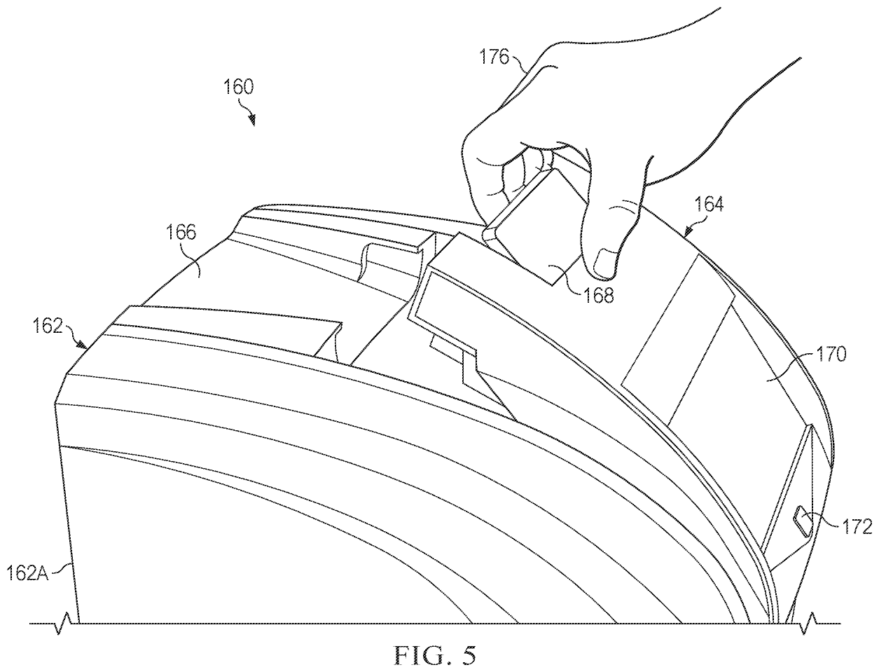

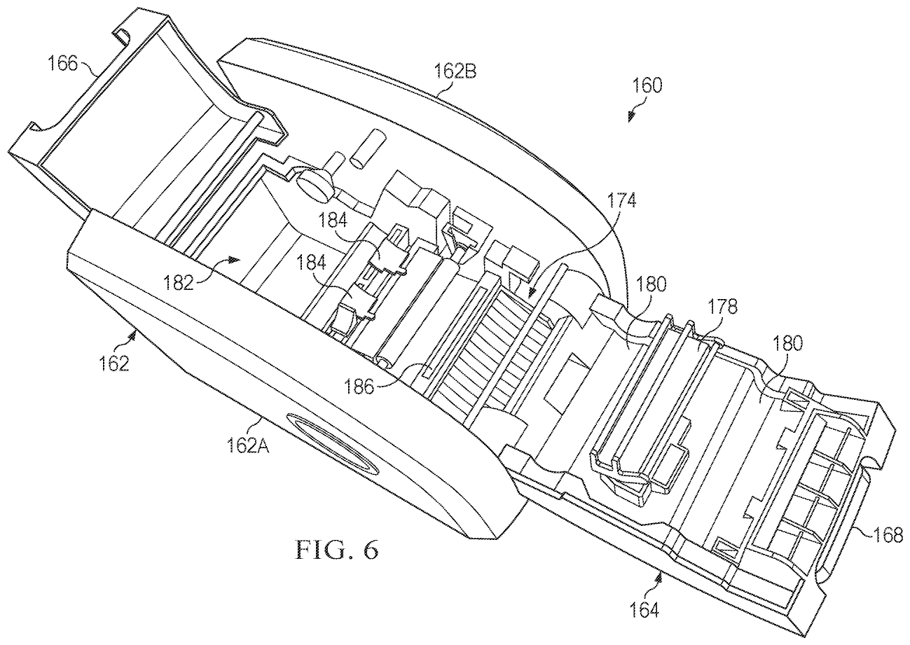

Turning to FIG. 5, the thermal printer 160 may be designed to articulate between a closed position whereby the second cover panel 166 is flush with the first cover panel 164, and an open position (see FIG. 6), thereby exposing the components enclosed within the first and second body portions 162A, 162B and the first and second cover panels 164, 166. The release latch 168 may engage a connection between the first and second cover panels 164, 166 such that a user 176 may separate or de-couple the first and second cover panels 164, 166 by pulling up on the release latch 168. The first and second cover panels 164, 166 may each be hingedly connected to the first and second body portions 162A, 162B via a hinge (not shown) or other connection means. Thus, when the release latch 168 is pulled by the user 176, the user 176 may then move each of the first and second cover panels 164, 166 up and away from the enclosed space, thereby exposing the internal components of the thermal printer 160.

Referring now to FIG. 6, the thermal printer 160 may include a printhead 178 and a ribbon holder 180 positioned on an interior surface of the first cover panel 164. A label well 182 may be positioned underneath the second cover panel 166, and one or more media guides 184 may be positioned between the label well 182 and the output region 174. The thermal printer 160 may include a cutter 186 positioned between the media guides 184 and the output region 174. Thus, printable media (e.g., a roll of printable labels) may be installed in the label well 182 before the thermal printer 160 is used. Such printable media may be fed through the media guides 184, printed on by the printhead 178 and ribbon (not shown) disposed in the ribbon holder 180, and cut by the cutter 186 before being dispensed from the thermal printer 160 via the output region 174. In some instances, the cutter 186 may be provided in the form of the printer cutter mechanism disclosed herein.

Although a specific exemplary thermal printer 160 is described, it should be appreciated that the thermal printer 160 for use with the printer cutter mechanism disclosed herein may include or omit additional components as known in the art.

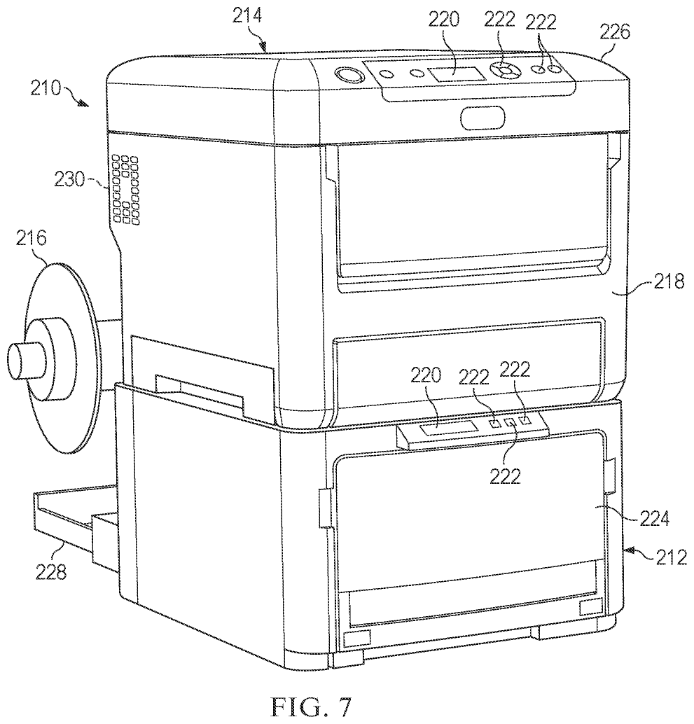

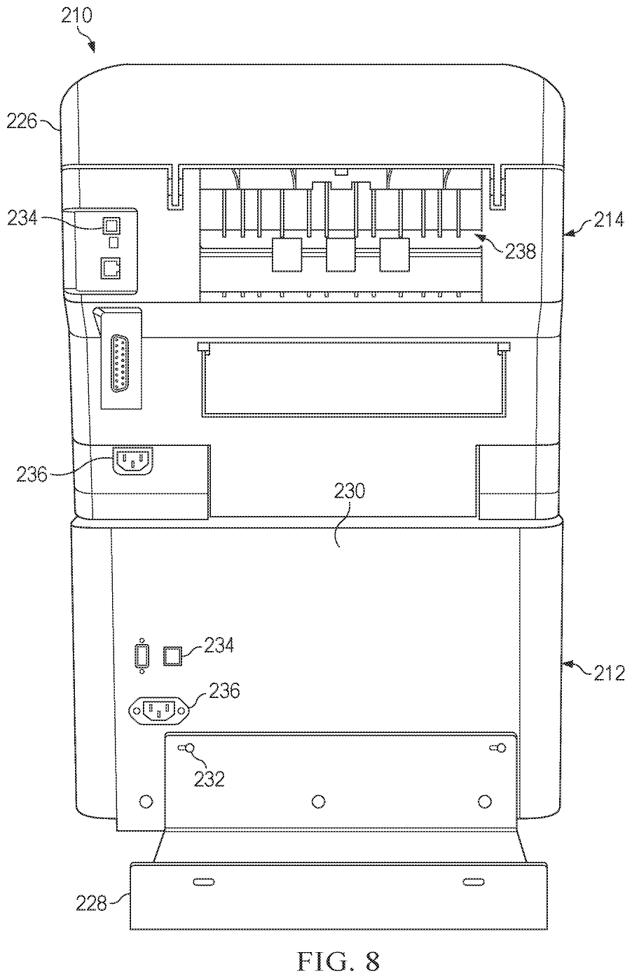

Turning to FIGS. 7-9, an exemplary LED or laser printer 210 may include a housing having a feeder assembly 212, a printer device 214 positioned on and supported by the feeder assembly 212, and a rewinder 216. On a front side 218 of the laser printer 210, one or more of the feeder assembly 212 and/or the printer device 214 may include a display 220 via which a user may interact with the laser printer 210 and one or more buttons 222 which may correspond to various settings or functionalities of the laser printer 210. The feeder assembly may include a front cover 224 positioned on the front side 218 and a top cover 226 positioned opposite the feeder assembly 212. The rewinder 216 may be positioned on a support plate 228. As shown best in FIG. 8, which depicts a back side 230 of the laser printer 210 without the rewinder 216, the support plate 228 may be coupled to the back side 230 via one or more fasteners 232. The laser printer 210 may also include one or more ports 234, one or more power outlets 236, and an exit slot 238 positioned on the back side 230.

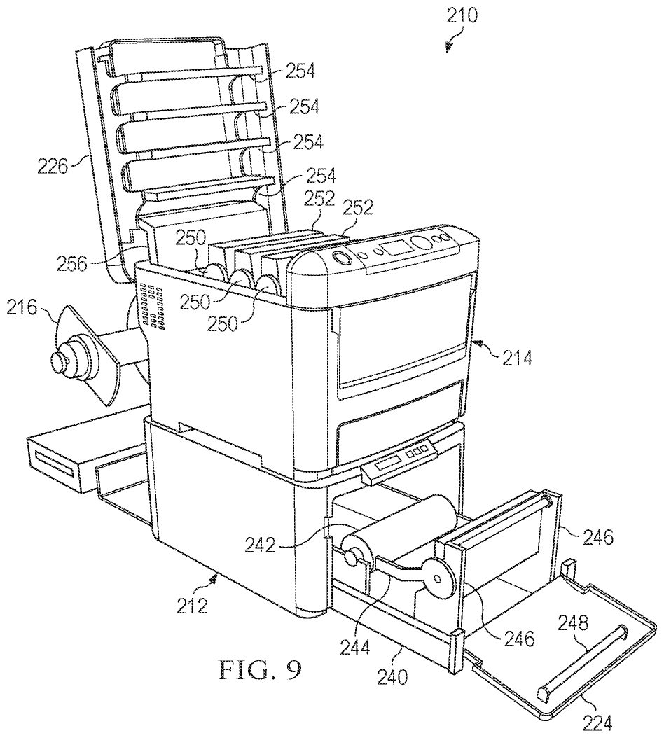

Referring to FIG. 9, the front cover 224 and top cover 226 may be opened to expose various internal components of the feeder assembly 212 and printer device 214, respectively. Internal components of the feeder assembly 212 may be positioned on and supported by a tray 240. The tray 240 may be slidably coupled to the feeder assembly 212 such that it may be retracted when the front cover 224 is opened. The tray 240 of the feeder assembly 212 may support one or more of a spindle pin 242, an extension arm 244, one or more media guides 246, and a static bar 248. The spindle pin 242 may provide a rotatable support structure for printable media to be imprinted by the printer device 214. The extension arm 244 and media guides 246 may help support or guide the media toward an opening (not shown) through which the media may pass from the feeder assembly 212 to the printer device 214. The media may be directed to pass over the static bar 248 before entering the printer device 214 and the static bar 248 may condition the media to attract toner (e.g., by imparting the media with an electrical charge).

Internal components of the printer device 214 may include one or more drum units 250, one or more toner cartridges 252, and one or more LED heads 254. In the exemplary printer of FIG. 9, the printer device 214 may include four drum units 250, four toner cartridges 252 (e.g., C, M, Y, and K toners), and four LED heads 254. The drum units 250 may be imparted uniformly or substantially uniformly with an initial electrical charge. For example, the printer device 214 may include a high voltage wire or a charge roller (not shown) configured to impart an electrical charge upon the drum units 250. The LED heads 254 may be arranged to direct light toward the drum units 250 and the light produced by the LED heads 254 may reverse the localized electrical charge of the drum units 250 in the areas impacted by the light. Thus, the LED heads 254 may selectively direct light toward particular areas of the drum units 250 that correspond to the image or text being printed.

Areas of the drum units 250 whose electrical charge has been reversed by the LED heads 254 may attract toner from the toner cartridges 252 (e.g., the toner may be imparted with an opposite electrical charge relative to the areas of the drum units 250 impacted by the LED heads 254). The toner may then be transferred to the printable media being fed to the printer device 214 from the feeder assembly 212 as the media (having been charged by the static bar 248) passes over the drum units 250. The media may then pass through a fuser (not shown), which may be provided in the form of one or more heated rollers that may melt the toner, thereby “fusing” the toner or otherwise causing the toner to adhere to the media. The printer device 214 may include a fuser release lever 256 extending upwardly from the fuser (not shown) such that a user may lift or remove the fuser from the printer device 214 (e.g., for maintenance).

In some instances, the printer device 214 may include a laser beam (not shown) and one or more mirrors (not shown) in lieu of the LED heads 254. In these instances, the laser beam may be selectively directed toward the drum units 250 to reverse the localized electrical charge in areas corresponding to the text or image being printed such that toner is attracted to those areas. The laser beam may be static, and a movable mirror or a plurality of movable mirrors may be configured to direct the laser beam toward particular areas of the drum units 250.

Although a specific exemplary laser printer 210 is described, it should be appreciated that the laser printer 210 for use with the material holder disclosed herein may include or omit additional components as known in the art.

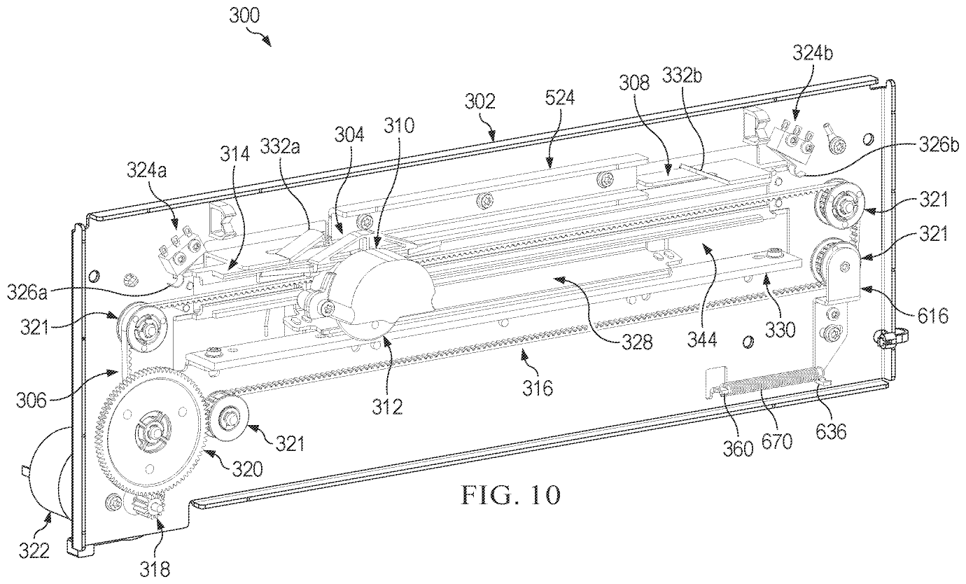

Now turning to FIG. 10, a cutter assembly 300 may be designed to sever a desired portion of a supply of printable media either before or after the media is imprinted. The cutter assembly 300 may be used with the inkjet printer 100, thermal printer 160, laser printer 210, or any other suitable printing device. For example, the cutter assembly 300 may be installed adjacent to the exit slot 114 of the inkjet printer 100, the output region 174 of the thermal printer 160, or the exit slot 238 of the laser printer 210 so as to slice the media as it is exiting the printer. It should be appreciated that the cutter assembly 300 may be positioned anywhere along the path of travel of the printable media such that the media may be cut prior to exiting the printer. The cutter assembly 300 may be installed within or otherwise configured for use with the printers disclosed herein in manners known in the art.

The cutter assembly 300 is provided in the form of a frame 302 supporting, among other things, one or more of a blade subassembly 304, a pulley subassembly 306, and a clamping subassembly 308. The pulley subassembly 306 may be operably coupled to the blade subassembly 304 and may be configured to facilitate operation thereof. For example, a carriage 310 of the blade subassembly 304 and a blade 312 retained in the carriage 310 may be arranged for translational motion along a guiderail 314 coupled to the frame 302. A belt 316 of the pulley subassembly 306 may be coupled to or otherwise engage the carriage 310 and may be configured to generate translational motion thereof along the guiderail 314 (e.g., across the frame 302).

In some instances, the pulley subassembly 306 may include one or more gears. In the example of FIG. 10, a driving gear 318 may be configured to generate rotation of a compound gear 320 connected to a plurality of pulleys 321 engaging the belt 316. A motor 322 configured to generate rotation of the driving gear 318 may drive translational motion of the blade 312 along the guiderail 314 via engagement between the driving gear 318, compound gear 320, pulleys 321, belt 316, and carriage 310. In other instances, gears (e.g., the driving gear 318 and the compound gear 320) may be omitted. Thus, the motor 322 may engage the pulleys 321 directly and may drive translational motion of the blade 312 along the guiderail 314 via engagement between the pulleys 321, belt 316, and carriage 310.

Two mechanical switches 324a, 324b in communication with the motor 322 may be supported by the frame 302 and positioned at opposing ends of the guiderail 314. The switches 324a, 324b may be configured to deactivate the motor 322 (e.g., terminate motion of the carriage 310) when the carriage 310 reaches either end of its path of motion along the guiderail 314. For example, each switch 324a, 324b may include a trigger 326a, 326b arranged such that at least a portion of the carriage 310 impacts the trigger 326 of one of the switches 324a, 324b as the carriage 310 approaches either end of the guiderail 314. Each trigger 326a, 326b may be configured to cause the switch 324 to which it is connected to deactivate the motor 322 upon impact. In other instances, electronic sensors or other mechanisms known in the art configured to deactivate the motor 322 may be provided in lieu of the switches 324a, 324b.

A spring-loaded clamp 328 of the clamping subassembly 308 may be configured to releasably immobilize or restrict the movement of a portion of printable media (not shown) during cutting. For example, the clamping subassembly 308 may cause the clamp 328 to apply a consistent downward pressure against the supply of media being cut (e.g., holding the media against a breaker bar 330), thereby preventing or reducing movement or rotation of the media relative to the breaker bar 330 during the translational motion of the blade 312. The carriage 310 may be configured to disengage the clamping subassembly 308 and release the media from the breaker bar 330 once a cutting operation is complete.

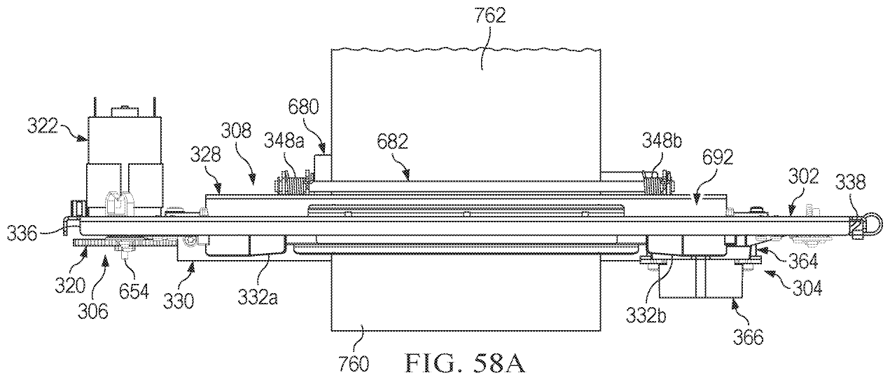

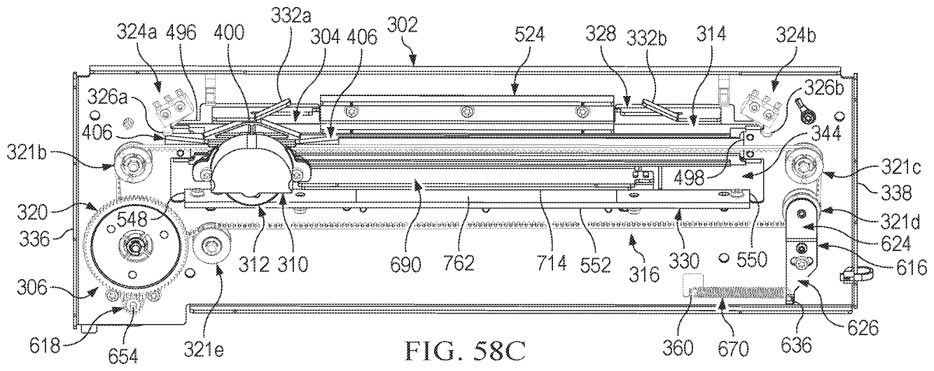

The clamping subassembly 308 may include two slanted deflection tabs 332a, 332b, positioned proximate to the switches 324a, 324b, respectively. The carriage 310 may be configured to engage one of the deflection tabs 332a, 332b as the carriage approaches either end of the guiderail 314. Each engagement between the carriage 310 and either of the deflection tabs 332a, 332b may involve the carriage 310 applying an upward force to the deflection tabs 332 and the deflection tab 332 applying a reciprocal downward force to the carriage 310. In this way, the carriage 310 may lift the clamp 328 and release the media being held against the breaker bar 330 by engaging one of the deflection tabs 332a, 332b. At the same time, the deflection tabs 332a, 332b may cause a downward motion of the carriage 310, thereby causing a cleaning action between the blade 312 and the breaker bar 330, as described below with reference to FIGS. 56 and 58C.

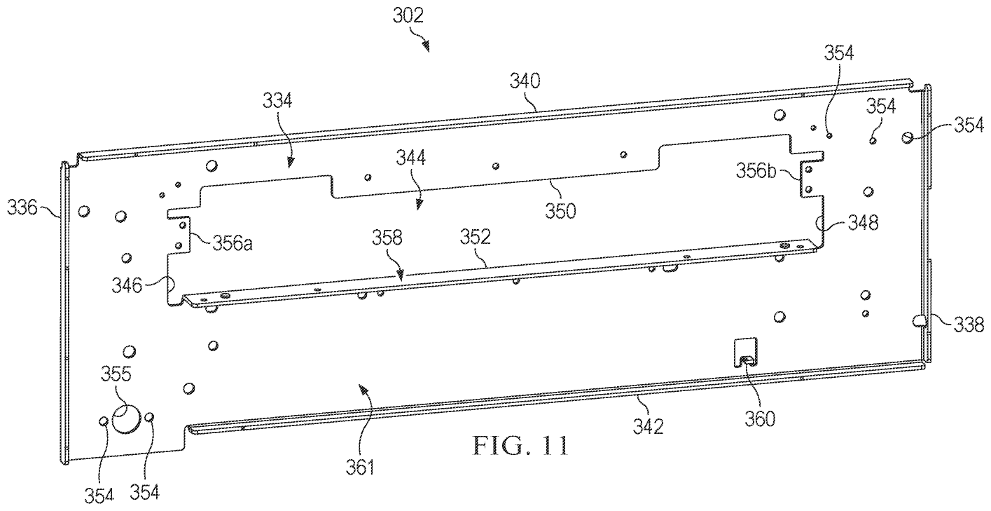

Turning to FIG. 11, the frame 302 may be provided in the form of a rectilinear body 334 defined by a first side 336, a second side 338 opposing the first side 336, a top end 340, and a bottom end 342 opposing the top end 340. A mouth 344 may be provided in the form of a substantially rectilinear opening extending through the body 334 defined by a first side 346, a second side 348 opposing the first side 346, a top end 350, and a bottom end 352 opposing the top end 350. The first side, second side, top end, and bottom end 346, 348, 350, 352 of the mouth 344 may correspond to the first side, second side, top end, and bottom end 336, 338, 340, 342 of the body 334. The body 334 may be provided in the form of any suitable metal, plastic, or composite material. For example, the body 334 may be provided in the form of carbon steel, stainless steel, wrought iron, aluminum, copper, titanium, tin, polycarbonate (PC), acrylonitrile butadiene styrene (ABS), polyvinyl chloride (PVC), polyethylene terephthalate (PET), carbon fiber, fiberglass, or any other suitable material.

A plurality of mounting holes 354 may be provided in the form of substantially circular openings extending entirely through the body 334. The mounting holes 354 may be configured to receive a fastening mechanism (e.g., a screw) and may be selectively positioned to support or couple various components of the cutter assembly 300 to the frame 302. For example, one or more mounting holes 354 positioned proximate to the junction between the first side 336 and the bottom end 342 of the body 334 may facilitate an attachment between the motor 322 and the frame 302. In addition, the frame 302 may include a motor port 355 configured to receive at least a portion of the motor 322 and positioned proximate to the junction between the first side 336 and the bottom end 342 of the body 334.

The body 334 may include a tab positioned along each of the first side 346 and the second side 348 of the mouth 344 and extending inwardly therefrom. For example, a first tab 356a may be positioned along the first side 346 of the mouth 344 and a second tab 356b may be positioned along the second side 348 of the mouth 344. Each of the tabs 356a, 356b may be positioned in substantially the same location with respect to the top end 350 and the bottom end 352 of the mouth 344 (e.g., the tabs 356a, 356b may be horizontally aligned). The tabs 356a, 356b may each include one or more mounting holes 354. In some instances, the tabs 356a, 356b may be configured to facilitate an attachment between the guiderail 314 and the frame 302.

Still referring to FIG. 11, the body 334 may also include a central shelf 358 extending along and outwardly from the bottom end 352 of the mouth 344 and oriented substantially perpendicularly with respect to the body 334. Additionally, an anchor 360 extending outwardly from the frame 302 may be disposed between the shelf 358 and the bottom end 342 of the body 334. The shelf 358 and the anchor 360 may each be connected to a front face 361 of the frame 302.

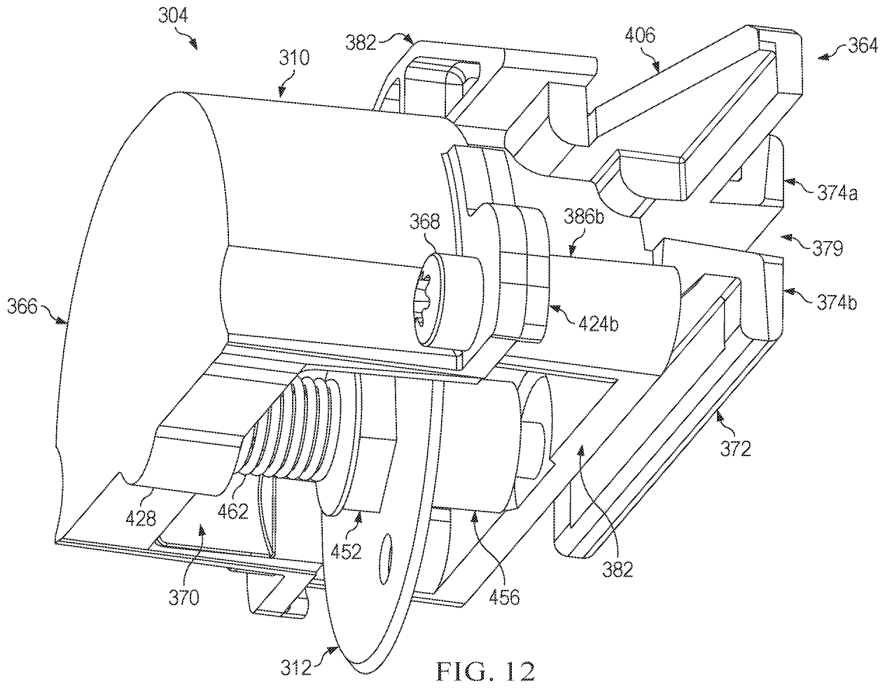

Turning to FIG. 12, the blade subassembly 304 may be provided in the form of a carriage 310 configured to retain the blade 312 and/or other components of the blade subassembly 304 therein. The carriage 310 may include a carrier 364 and a substantially semicircular cover 366 coupled thereto via one or more fasteners 368. The carrier 364 and the cover 366 may at least partially surround the blade 312. Together, the carrier 364 and cover 366 may form an opening 370 configured to permit at least a portion of the blade 312 to extend downwardly therethrough.

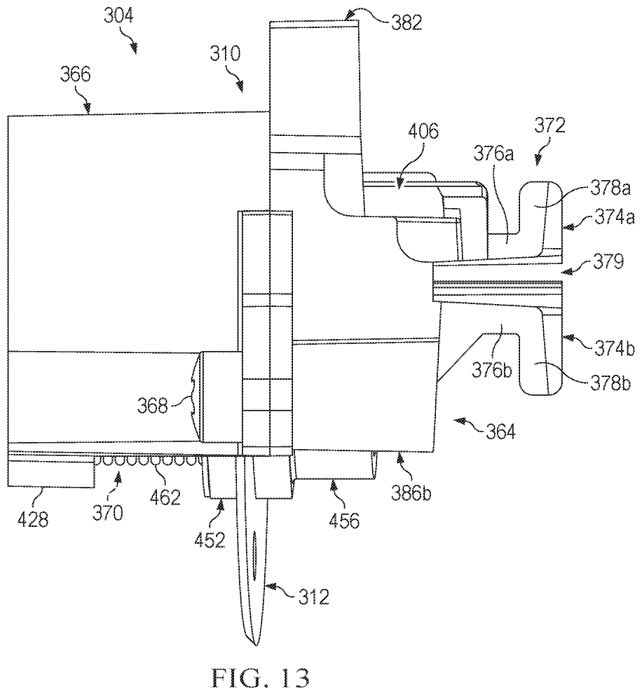

As best shown in FIG. 13, the carrier 364 may be movably coupled to or mounted on the guiderail 314 via a substantially T-shaped runner 372 positioned opposite the cover 366. The runner 372 may be provided in the form of two complementary angular members 374a, 374b. Each of the angular members 374a, 374b may include an arm 376a, 376b extending outwardly from the carrier 364 that terminate at a point 378a, 378b extending in a direction substantially perpendicular to the arm 376. The point 378a of the first angular member 374a may extend upwardly with respect to the arm 376a and the point 378b of the second angular member 374b may extend downwardly with respect to the arm 376b. The arms 376a, 376b may be oriented substantially parallel to one another and may be separated such that a gap 379 is provided therebetween (e.g., positioned between the arms 376a, 376b of the angular members 374a, 374b).

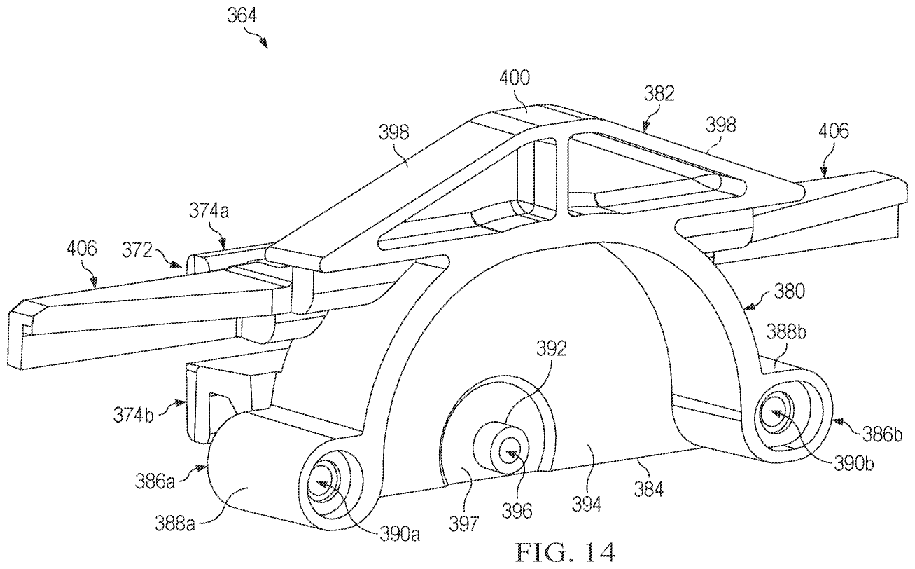

Turning to FIG. 14, the carrier 364 may include a substantially semicircular blade region 380 and a peak region 382 disposed above the blade region 380. The blade region 380 may include a substantially flat bottom edge 384 extending between two connection shafts 386a, 386b. Each connection shaft 386a, 386b may include a substantially cylindrical sidewall 388a, 388b defining a carrier opening 390a, 390b extending therethrough. The carrier openings 390a, 390b may each be configured to receive a fastener (e.g., a fastener 368) and to facilitate coupling between the carrier 364 and the cover 366. In some instances, the carrier openings 390a, 390b may be threaded (e.g., configured to receive fasteners 368 having complementary threading). In other instances, the carrier openings 390a, 390b may be configured to securely receive the fasteners 368 via any other suitable mechanism (e.g., a press fit).

A substantially cylindrical first collar 392 may be positioned on an interior wall 394 of the blade region 380 and extend outwardly therefrom. In some instances, the first collar 392 may be disposed centrally between the two connection shafts 386a, 386b. The first collar 392 may be oriented substantially parallel with respect to the connection shafts 386a, 386b and may define a substantially cylindrical first silo 396 therein. A depression 397 having the shape of at least a portion of a circle may surround (e.g., be substantially concentric with) the first collar 392.

The peak region 382 positioned atop the blade region 380 (e.g., positioned opposite the bottom edge 384) may be imparted with a triangular or trapezoidal shape. In some instances, the peak region 382 may include two substantially symmetrical sloped walls 398 and an apex 400 where the sloped walls 398 converge. In some instances, one or more of the sloped walls 398 and the apex 400 may be configured to engage the clamping subassembly 308 as described above with reference to FIG. 10 when the cutter assembly 300 is in use. The peak region 382 may be formed integrally with the blade region 380 or may be coupled to the blade region 380 and extend upwardly therefrom.

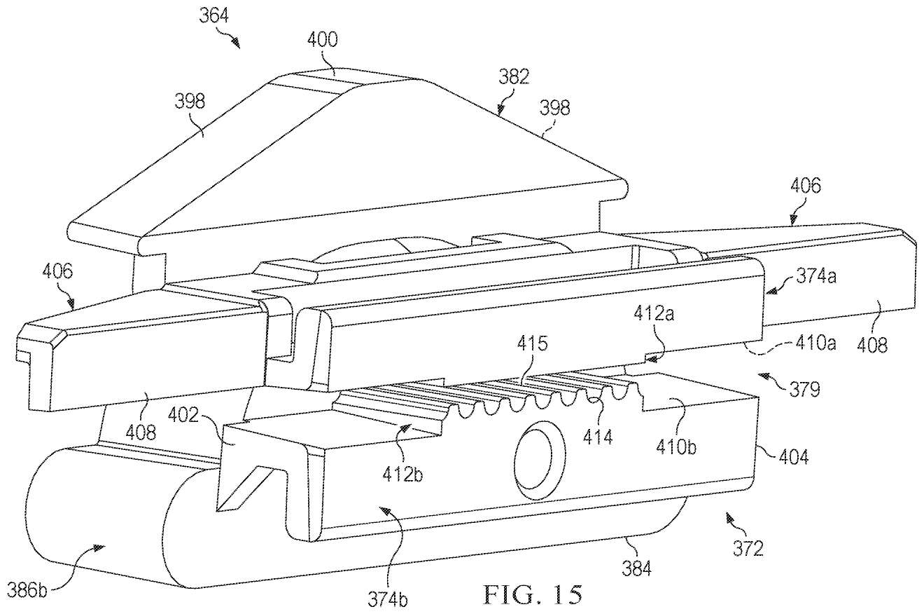

As best shown in FIG. 15, each of the angular members 374a, 374b may extend linearly between a first end 402 and a second end 404 of the runner 372. The carrier 364 may further include two appendages 406 attached to the first angular member 374a at each of the first and second ends 402, 404 and extending outwardly therefrom. Each appendage 406 may be defined by a vertical wall 408 arranged to be substantially flush with or parallel to the guiderail 314 when the cutter assembly 300 is assembled.

The angular members 374a, 374b may each include a first interior surface 410a and a second interior surface 410b, respectively. The interior surfaces 410a, 410b may each extend between the first and second ends 402, 404 of the runner 372 and may each be substantially perpendicular with respect to the vertical walls 408. The first interior surface 410a may have a first raised portion 412a and the second interior surface 410b may have a second raised portion 412b. The raised portions 412a, 412b may protrude inwardly (e.g., in the direction of the gap 379) from the interior surfaces 410a, 410b, respectively. The first raised portion 412a may be provided in the form of a substantially rectangular protrusion defined by a substantially smooth surface. The second raised portion 412b may be provided in the form of a substantially rectangular protrusion including a plurality of notches 414 formed along a notched surface 415 of the second raised portion 412b (e.g., the surface opposing the first raised portion 412a). The notches 414 may be configured to facilitate engagement between the carrier 364 and the belt 316 of the pulley subassembly 306. In some instances, the notches 414 may be substantially semicircular in shape. In other instances, the notches 414 may be imparted with any suitable shape or structure.

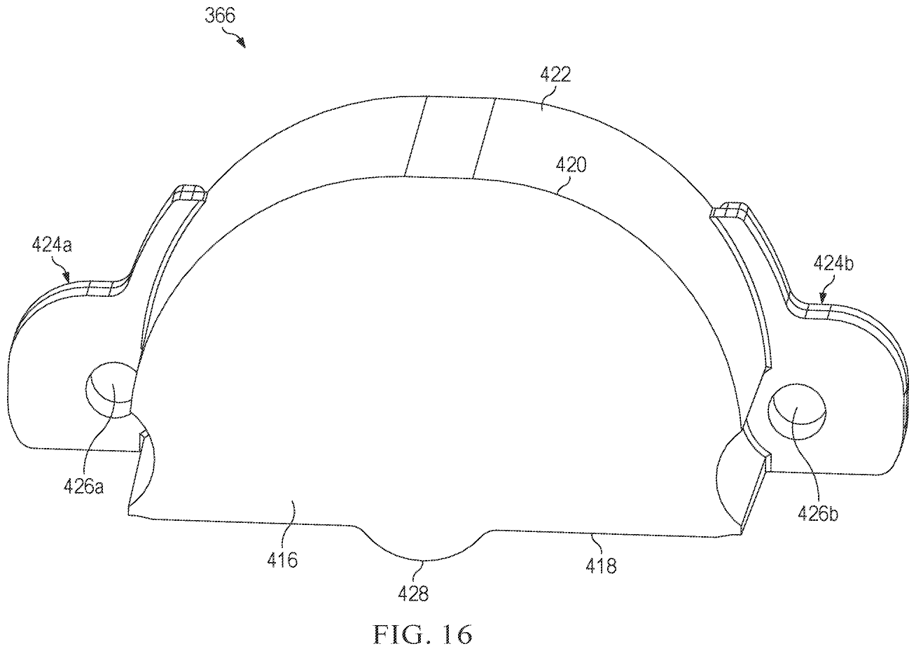

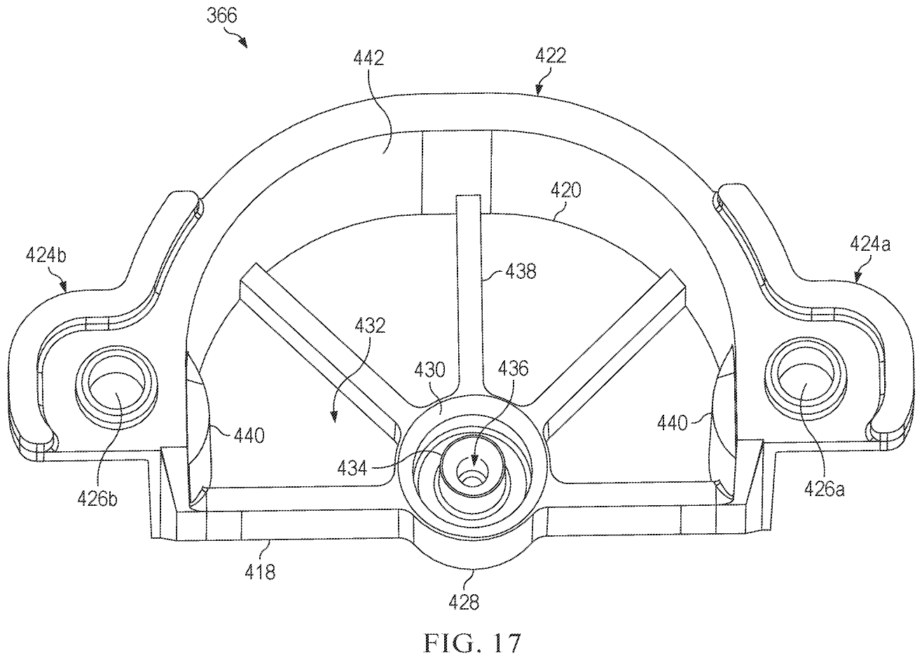

Now turning to FIGS. 16 and 17, the semicircular cover 366 may be provided in the form of a substantially vertical sidewall 416 and an endwall 422 circumscribing the sidewall 416 and protruding outwardly therefrom. The cover 366 is defined by a substantially flat bottom edge 418 and a substantially semicircular top edge 420. The cover 366 may include two wings 424a, 424b coupled to the endwall 422 and extending outwardly therefrom. Each of the wings 424a, 424b may include a cover opening 426a, 462b configured to receive a fastener (e.g., a fastener 368) and to facilitate coupling between the carrier 364 and the cover 366. The cover 366 may further include a rounded stepped protrusion 428 disposed along the bottom edge 418 of the sidewall 416 and extending therefrom. In some instances, the protrusion 428 may be positioned substantially equidistant from the two wings 424a, 424b. In other instances, the protrusion 428 may be offset with respect to the wings 424a, 424b.

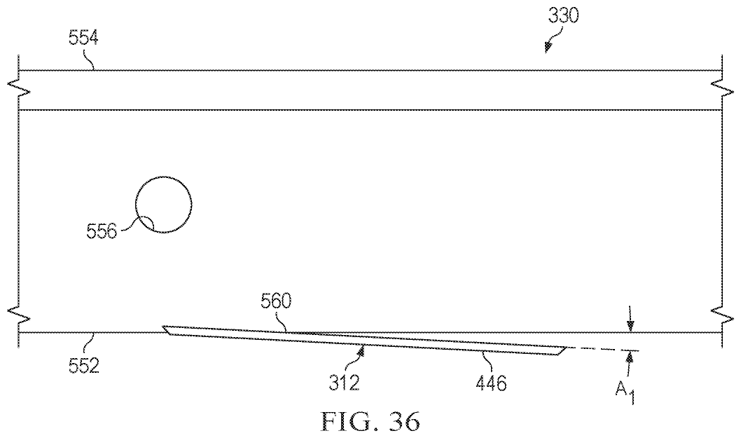

As best shown in FIG. 17, the protrusion 428 may be configured to accommodate a portion of a ring wall 430 disposed on an interior surface 432 of the sidewall 416. A second collar 434 may be positioned within the ring wall 430 and may define a substantially cylindrical second silo 436 therein. In some instances, the second collar 434 may be positioned asymmetrically on the interior surface 432 of the sidewall 416 with respect to the wings 424a, 424b. In some instances, the second collar 434 may be positioned closer to the wing 424a than to the wing 424b. Thus, the first and second collars 392, 434 may be offset with respect to one another such that the blade 312 is retained within the carriage 310 at an angle with respect to the breaker bar 330 as described below with reference to FIG. 36. In some instances, one or more spokes 438 designed to impart structural stability to the cover 366 may be disposed on the interior surface 432 and extend radially between the ring wall 430 and the endwall 422. In other instances, the spokes 438 may be omitted. Additionally, in some instances, one or more bulge members 440 may be provided on an interior surface 442 of the endwall 422 (e.g., to provide positional stability to the blade 312 when the cutter assembly 300 is in use). For example, two bulge members 440 imparted with a generally curved or parabolic structure may be disposed on the interior surface 442 proximate to each of the wings 424a, 424b. In other instances, the bulge members 440 may be omitted.

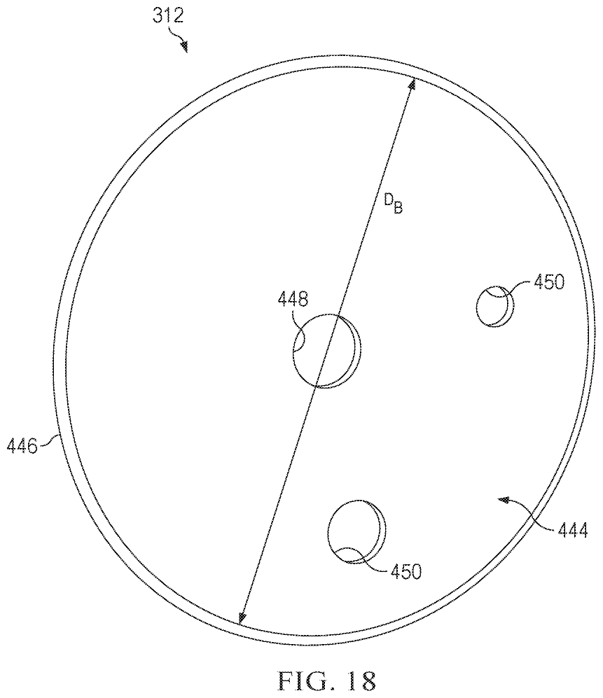

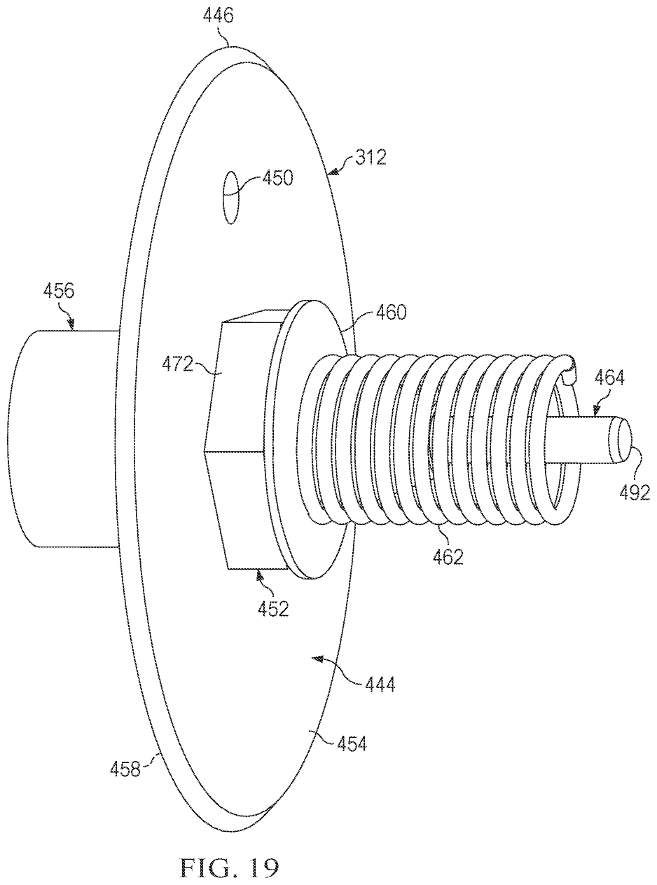

Now turning to FIGS. 18 and 19, the blade 312 may be provided in the form of a substantially circular body 444 defined by a cutting edge 446. A mounting hole 448 may be provided in the form of a circular opening extending through the body 444 and may be positioned centrally with respect to the cutting edge 446. In some instances, the blade 312 may include one or more secondary holes 450 (e.g., to reduce the weight of the blade 312, to aid in heat dissipation, to improve cost efficiency, etc.). In other instances, the secondary holes 450 may be omitted. The body 444 may be provided in the form of a ferrous metal such as carbon steel, stainless steel, alloy steel, cast iron, wrought iron, or any other suitable material. Additionally, in some instances, the blade 312 may undergo a through hardening process designed to increase the hardness of the entire body 444 of the blade 312. In other instances, the blade 312 may receive any case hardening treatment or any other treatment (e.g., nitriding treatment, carburizing treatment, nitro-carburizing treatment, powder coating, and the like) known in the art to harden steel or other metals.

The blade 312 may be defined by a diameter DB measured between two points positioned exactly opposite one another along the cutting edge 446. The diameter DB may be imparted with a value of about 12 millimeters (mm) to about 30 mm (or 12 mm to 30 mm), or from about 20 mm to about 30 mm (or 20 mm to 30 mm). For example, the diameter DB may be imparted with a value of at least about 12 mm (or at least 12 mm), or at least about 14 mm (or at least 14 mm), or at least about 16 mm (or at least 16 mm), or at least about 18 mm (or at least 18 mm), or at least about 20 mm (or at least 20 mm), or at least about 22 mm (or at least 22 mm), or at least about 24 mm (or at least 24 mm), or at least about 26 mm (or at least 26 mm), or at least about 28 m (or at least 28 mm), or at least about 30 mm (or at least 30 mm). In some instances, the diameter DB may be imparted with a value of about 25.4 mm (or 25.4 mm).

As best shown in FIG. 19, the blade 312 may be positioned between a screw member 452 abutting a first side 454 of the blade 312 and a nut member 456 abutting a second side 458 of the blade 312. A washer 460 may be positioned adjacent to the screw member 452 and opposite the blade 312 with respect to the screw member 452. A spring 462 may be positioned adjacent to the washer 460 and opposite the screw member 452 with respect to the washer 460. The blade 312, screw member 452, nut member 456, washer 460, and spring 462 may be arranged coaxially, such that a rod 464 may extend linearly therethrough.

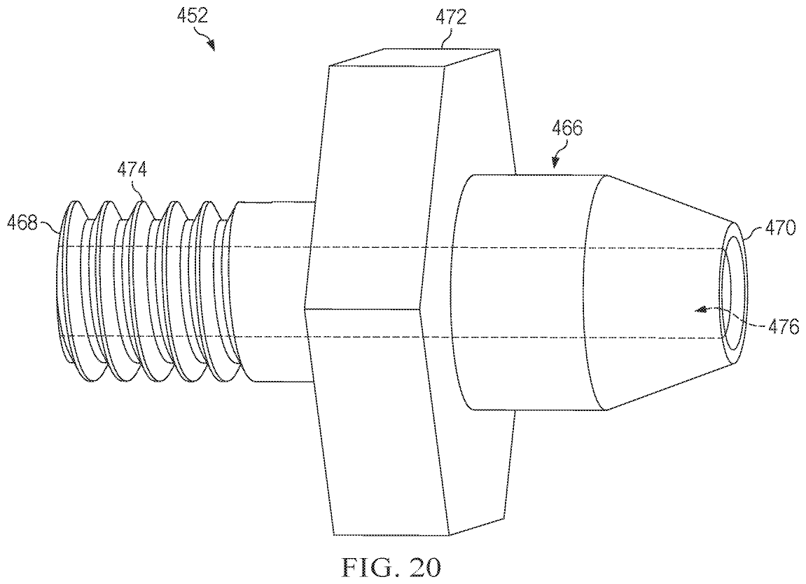

Turning to FIG. 20, the screw member 452 may be provided in the form of a tubular body 466 defined by a first end 468 and a second end 470. A polygonal first cuff 472 may be positioned between the first and second ends 468, 470 and surround the body 466. In some instances, the first cuff 472 may be hexagonal in shape. In other instances, the first cuff 472 may be imparted with any suitable shape. The body 466 may include a threaded segment 474 positioned adjacent to the first end 468. The body 466 may define a substantially cylindrical first conduit 476 extending entirely therethrough (e.g., extending between the first and second ends 468, 470). The first conduit 476 may be configured to receive the rod 464. In some instances, the first conduit 476 may be imparted with substantially the same structure as the rod 464.

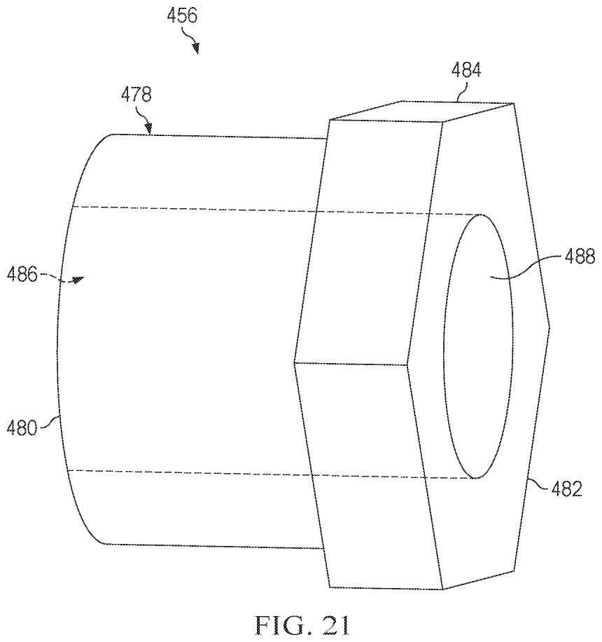

As best shown in FIG. 21, the nut member 456 may also be provided in the form of a tubular body 478 defined by a first end 480 and a second end 482. The body 478 of the nut member 456 may be substantially cylindrical in shape, except that a polygonal second cuff 484 may be positioned at the second end 482 and may surround the body 478. In some instances, the second cuff 484 may be identical or substantially identical to the first cuff 472. For example, the first and second cuffs 472, 484 may each be substantially hexagonal in shape. In other instances, the first and second cuffs 472, 484 may be identical and may be imparted with any other suitable shape, or the first and second cuffs 472, 484 may be provided in different forms. The body 478 may also define a substantially cylindrical second conduit 486 extending entirely therethrough (e.g., extending between the first and second ends 480, 482). In some instances, at least a portion of an interior surface 488 defining the second conduit 486 may be imparted with threading configured to receive and engage the threaded segment 474 of the screw member 452.

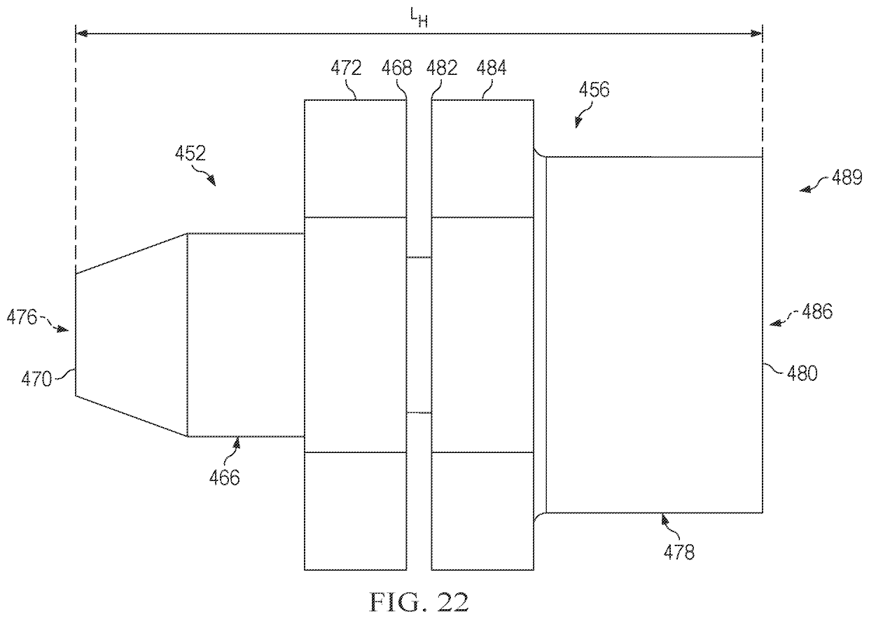

Now turning to FIG. 22, together, the screw member 452 and the nut member 456 may constitute a hub 489 designed to support and/or retain the blade 312. The hub 489 may be defined by an overall hub length LH measured linearly between the second end 470 of the screw member 452 and the first end 480 of the nut member 456. In some instances, the hub length LH may be imparted with a value of about 5 mm to about 30 mm (or 5 mm to 30 mm), or from about 10 mm to about 20 mm (or 10 mm to 20 mm). For example, the hub length LH may be imparted with a value of at least about 5 mm (or at least 5 mm), or at least about 10 mm (or at least 10 mm), or at least about 15 mm (or at least 15 mm), or at least about 20 mm (or at least 20 mm), or at least about 25 mm (or at least 25 mm), or at least about 30 mm (or at least 30 mm). In some instances, the hub length LH may be imparted with a value of about 13.3 mm.

In some instances, the ratio between the diameter DB of the blade 312 and the hub length LH (i.e., DB/LH) may be less than 2.0. For example, the ratio between the diameter DB of the blade 312 and the hub length LH may be about 1.9. In other instances, the ratio between the diameter DB of the blade 312 and the hub length LH may be greater than 2.0. In other instances, the ratio between the diameter DB of the blade 312 and the hub length LH may be from about 0.4 to about 6 (or 0.4 to 6), or from about 0.4 to about 2.4 (or 0.4 to 2.4), or from about 0.4 to less than 2.0 (or 0.4 to less than 2.0), or from about 0.4 to about 1.9 (or 0.4 to 1.9), or from about 1 to about 1.9 (or 1 to 1.9), or from about 1.5 to about 1.9 (or 1.5 to 1.9), or from about 1.8 to about 1.9 (or 1.8 to 1.9).

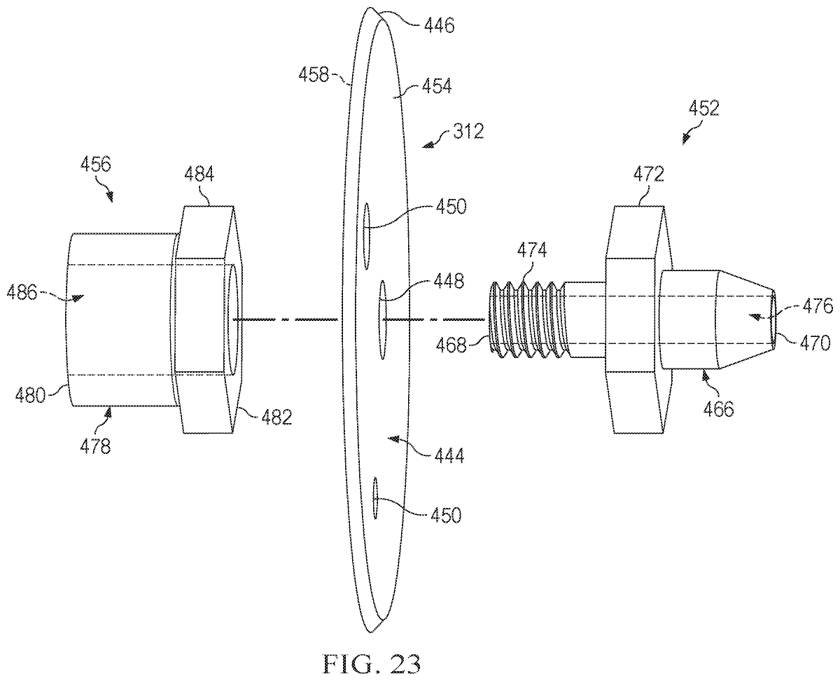

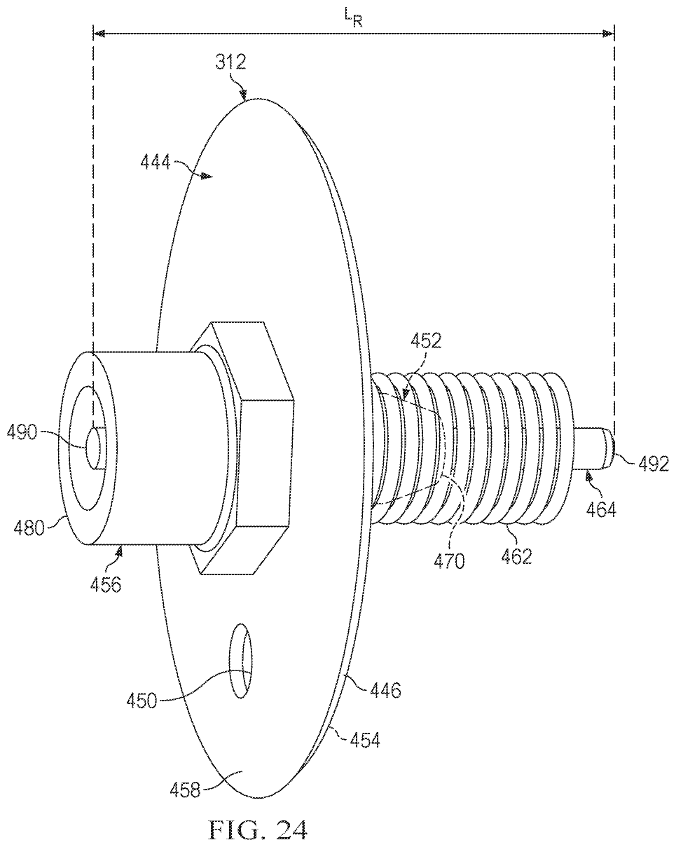

As best shown in FIG. 23, the first end 468 of the screw member 452 may be inserted through the mounting hole 448 of the blade 312 and into the second conduit 486 of the nut member 456 in order to install the blade 312 on the hub 489 between the first and second cuffs 472, 484. Thus, the screw member 452 may be coupled to the nut member 456 via engagement between the threaded segment 474 and the threaded interior surface 488 (or the threaded portion of the interior surface 488) with the blade 312 positioned therebetween. Subsequently, as best shown in FIG. 24, the rod 464 may be inserted into the first conduit 476 and extend entirely therethrough. Thus, the rod 464 may extend through (e.g., form a central axis of) the screw member 452, the nut member 456, and the blade 312 such that a first end 490 of the rod 464 may be substantially flush or coplanar with the first end 480 of the nut member 456 and a second end 492 of the rod 464 may extend beyond the second end 470 of the screw member 452. The second end 492 of the rod 464 may then be inserted through the washer 460 and the spring 462 such that the washer 460 is positioned adjacent to the first cuff 472 of the screw member 452 and the spring 462 abuts or is positioned adjacent to the washer 460 (see FIG. 19).

As can be seen in FIG. 24, the rod 464 may be defined by an overall rod length LR measured linearly between the first end 490 and the second end 492 of the rod 464. In some instances, the rod length LR may be imparted with a value of about 10 mm to about 40 mm (or 10 mm to 40 mm), or from about 15 mm to about 25 mm (or 15 mm to 25 mm). For example, the rod length LR may be imparted with a value of at least about 10 mm (or at least 10 mm), or at least about 15 mm (or at least 15 mm), or at least about 20 mm (or at least 20 mm). In some instances, the rod length LR may be imparted with a value of about 20 mm (or 20 mm).

In some instances, the ratio between the diameter DB of the blade 312 and the rod length LR (i.e., DB/LR) may be less than 2.0. For example, the ratio between the diameter DB of the blade 312 and the rod length LR may be about 1.3. In other instances, the ratio between the diameter DB of the blade 312 and the rod length LR may be greater than 2.0. In other instances, the ratio between the diameter DB of the blade 312 and the rod length LR may be from about 0.3 to about 3 (or 0.3 to 3), or from about 0.3 to about 2 (or 0.3 to 2), or from about 0.3 to less than 2.0 (or 0.3 to less than 2.0), or from about 0.3 to about 1.9 (or 0.3 to 1.9), or from about 0.75 to about 1.9 (or 0.75 to 1.9), or from about 1 to about 1.9 (or 1 to 1.9), or from about 1 to about 1.5 (or 1 to 1.5), or from about 1 to about 1.3 (or 1 to 1.3), or from about 1.2 to about 1.3 (or 1.2 to 1.3).

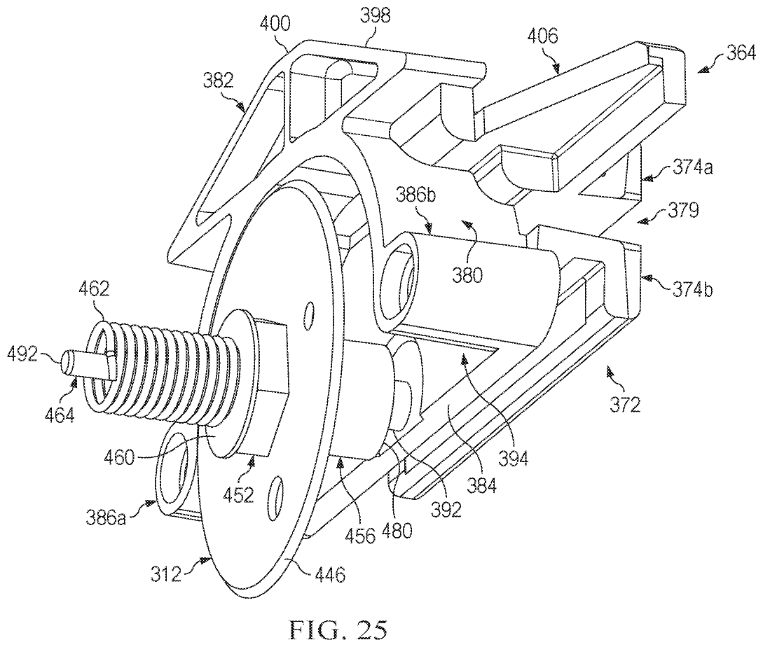

Now turning to FIG. 25, to install the blade 312 within the carrier 364, the first end 480 of the nut member 456 and the rod 464 may be aligned with the first collar 392 such that the first silo 396 receives the first end 490 of the rod 464. Subsequently, the cover 366 may be coupled to the carrier 364 via the fasteners 368 (see FIG. 12). The cover openings 426a, 426b of the cover 366 may align with the carrier openings 390a, 390b of the carrier 364 such that the fasteners 368 may be inserted therethrough and securely received by the carrier openings 390a, 390b. Due to the alignment of the cover openings 426a, 426b with the carrier openings 390a, 390b, the second collar 434 may be positioned such that the second silo 436 can receive the second end 492 of the rod 464. Thus, the rod 464 may be securely positioned or suspended at an angle between the first silo 396 and the second silo 436 due to the offset between the first and second collars 392, 434. In this way, the carrier 364 and the cover 366 may retain the blade 312 at an angle within the carriage 310.

Further, at least a portion of the spring 462 proximate to the second end 492 of the rod 464 may be received by the ring wall 430 of the cover 366 when the carriage 310 is assembled to retain the blade 312. In this way, the spring 462 may impart stability to the blade 312 and/or other components of the blade subassembly 304 by applying a stabilizing force to the washer 460. The carriage 310 may be configured to retain the blade 312 at a fixed angle therein regardless of whether the cutter assembly 300 is in use.

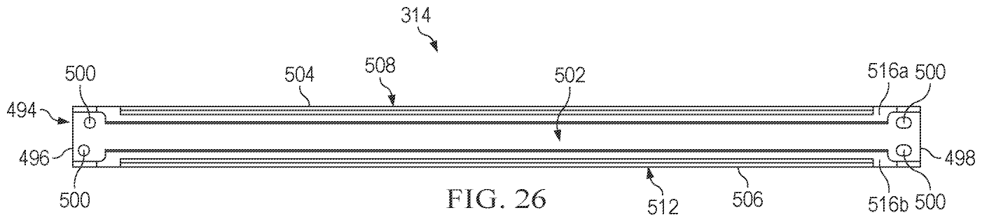

Turning now to FIG. 26, the guiderail 314 may be provided in the form of a rectilinear body 494 defined by a first side 496 and a second side 498 opposing the first side 496. One or more openings 500 configured to facilitate attachment of the guiderail 314 to the frame 302 may be formed in the body 494 and extend entirely therethrough. For example, the body 494 may include two openings 500 proximate to the first side 496 and two openings 500 proximate to the second side 498.

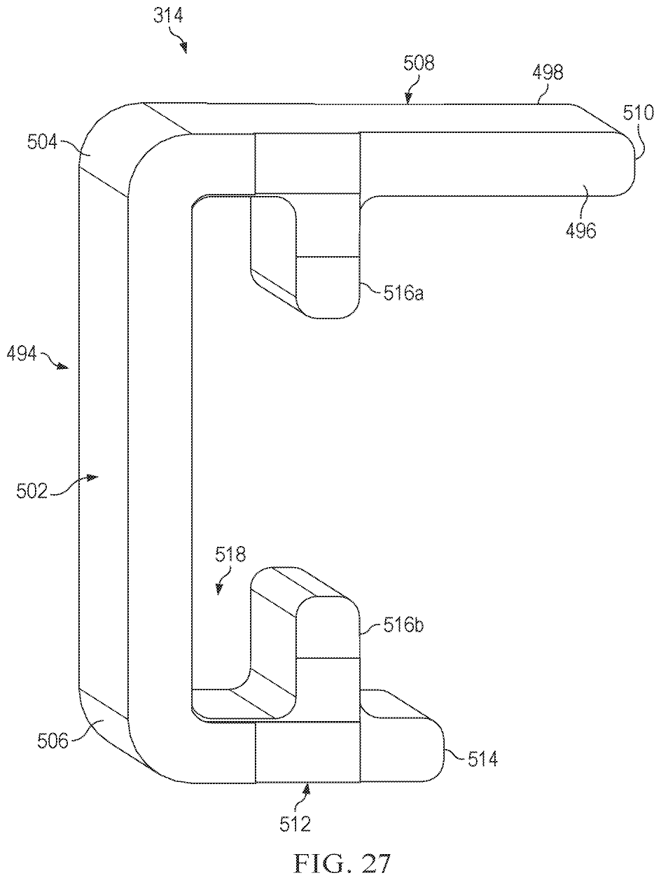

As best shown in FIG. 27, the body 494 may include a rear wall 502 having a top end 504 and a bottom end 506. The body 494 may further include an upper lip 508 extending outwardly from the top end 504 of the rear wall 502 and terminating at a distal end 510 thereof, and a lower lip 512 extending outwardly from the bottom end 506 of the rear wall 502 and terminating at a distal end 514 thereof. The upper and lower lips 508, 512 may be oriented substantially perpendicularly with respect to the rear wall 502. A rail member 516 configured to engage the runner 372 of the carrier 364 and extending at least partially between the first and second sides 496, 498 of the body 494 may be disposed on each of the upper and lower lips 508, 512. For example, a first rail member 516a may be disposed along the upper lip 508 and extend downwardly therefrom (e.g., toward the lower lip 512). A second rail member 516b may be disposed along the lower lip 512 and extend upwardly therefrom (e.g., toward the upper lip 508). In this way, the rail members 516 may define a track 518 along which the runner 372 may move laterally with respect to the guiderail 314.

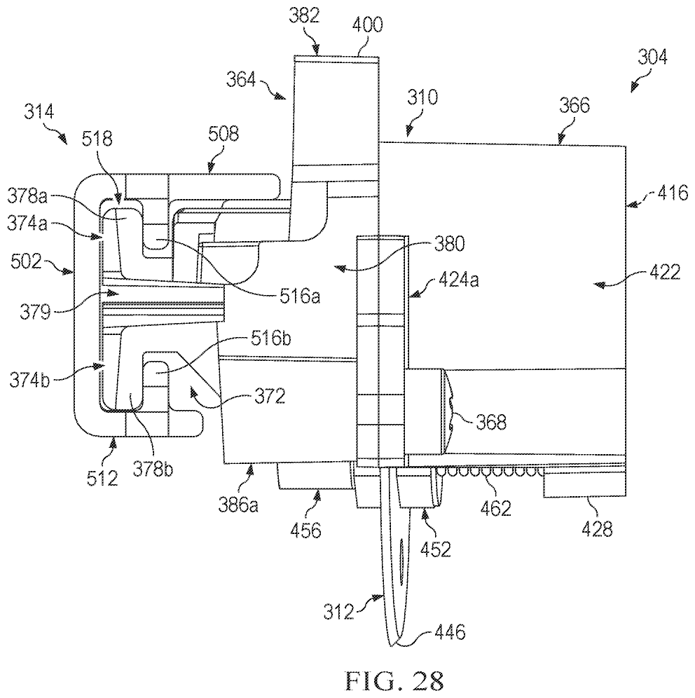

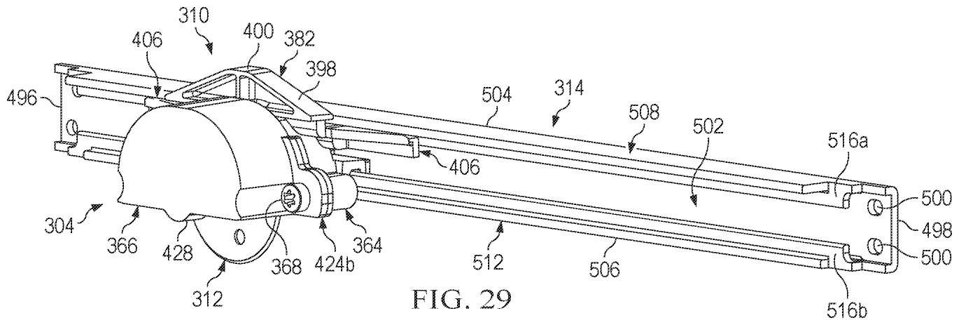

Turning to FIG. 28, the carrier 364 may be slidably coupled to or installed along the guiderail 314 via the runner 372. For example, the angular members 374a, 374b may occupy the track 518 defined by the rail members 516 of the guiderail 314. In particular, the point 378a of the first angular member 374a may be positioned between the first rail member 516a and the rear wall 502 of the guiderail 314. Likewise, the point 378b of the second angular member may be positioned between the second rail member 516b and the rear wall 502 of the guiderail 314. Thus, the carriage 310 may be retained by the guiderail 314 via engagement between the runner 372 and the rail members 516. In this way, the blade subassembly 304 may be configured to undergo translational movement between the first and second sides 496, 498 of the guiderail 314 (see FIG. 29). As shown in FIG. 29, the appendages 406 may be oriented parallel with respect to the guiderail 314 and may rest against the first rail member 516a (e.g., the vertical wall 408 of each appendage 406 may be in contact or substantially flush with the first rail member 516a).

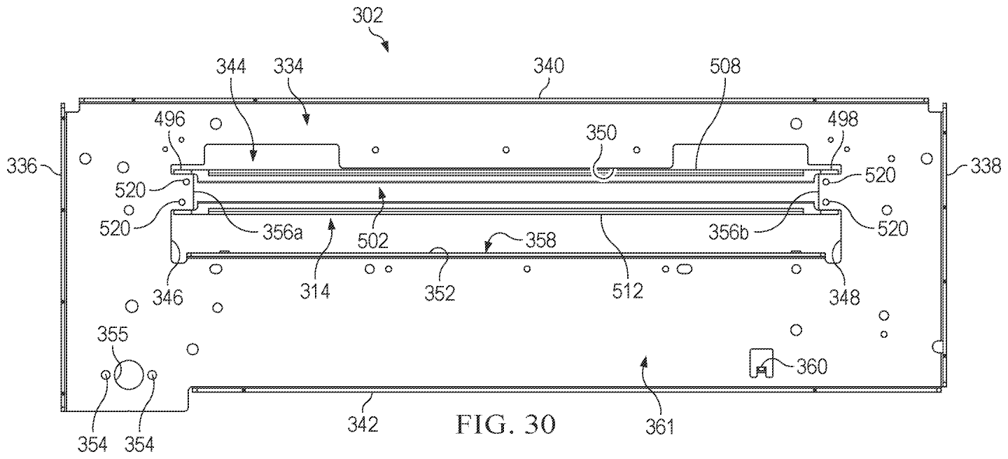

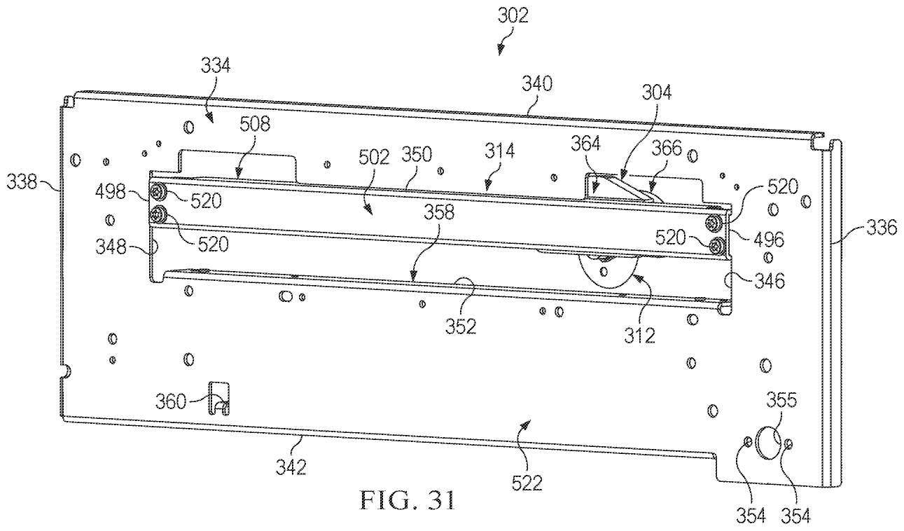

Turning now to FIGS. 30-32, the guiderail 314 may be coupled to the frame 302 via one or more fasteners 520. The fasteners 520 may be provided in the same form as or a different form as compared to the fasteners 368 used to assemble the carriage 310. The openings 500 proximate to the first and second sides 496, 498 of the body 494 of the guiderail 314 may be aligned with the mounting holes 354 positioned on the first and second tabs 356a, 356b, respectively, of the frame 302. Thus, the fasteners 520 may extend through each of the body 494 of the guiderail 314 and the tabs 356a, 356b of the frame 302 and may be securely received by one or both of the openings 500 and the mounting holes 354 (e.g., via engagement between complementary threaded surfaces thereof, via a press fit, or via any other suitable mechanism known in the art).

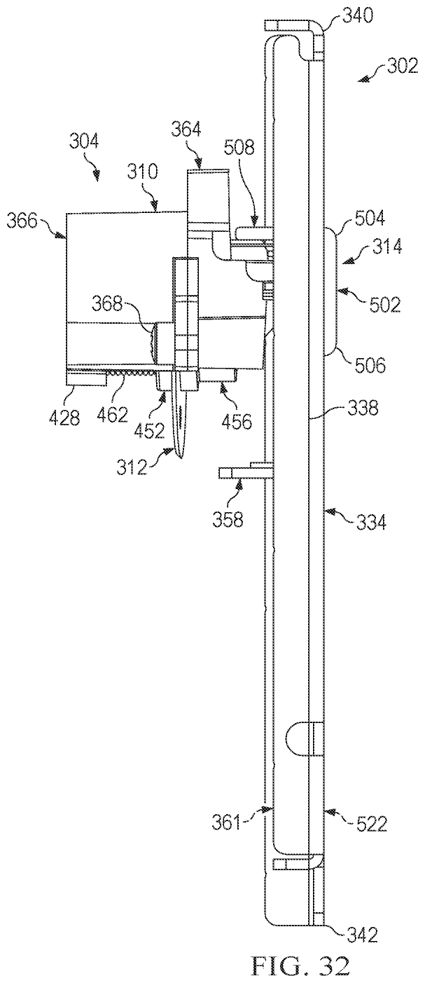

The rear wall 502 of the guiderail 314 may be disposed behind the frame 302 (e.g., adjacent to a rear face 522 opposite the front face 361 of the frame 302). Thus, the fasteners 520 may extend first through the rear wall 502 and then through the rear face 522 of the frame 302. The guiderail 314 may be disposed between the top and bottom ends 350, 352 of the mouth 344 and may extend linearly between the first and second sides 346, 348 of the mouth 344 (e.g., between the tabs 356a, 356b). As best seen in FIG. 32, the guiderail 314 and blade subassembly 304 may be configured such that the upper lip 508 of the guiderail extends beyond the front face 361 of the frame 302 and the blade subassembly is disposed either partially or entirely in front of the front face 361 (e.g., opposite the rear face 522 with respect to the body 334).

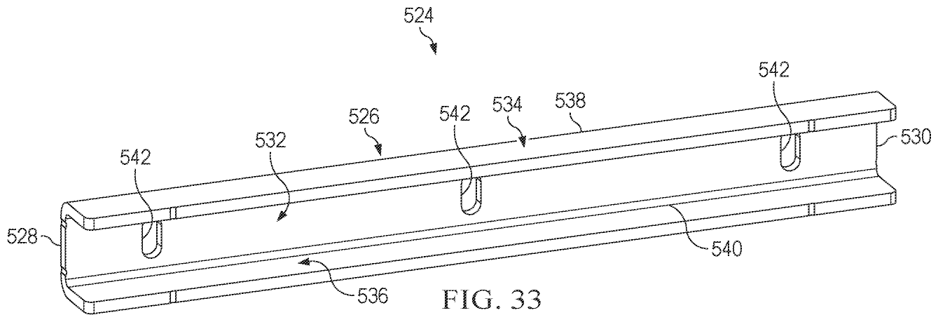

Turning to FIG. 33, a support rail 524 designed to impart structural rigidity and/or stability to the guiderail 314, the frame 302, and/or other components of the cutter assembly 300 may be provided in the form of a rectilinear body 526 defined by a first side 528 and a second side 530 opposing the first side 528. The body 526 may include a rear wall 532, an upper lip 534, and a lower lip 536, each of which may extend linearly between the first and second sides 528, 530. The rear wall 532 may be provided in the form of a substantially rectangular panel. The upper and lower lips 534, 536 may be connected to opposing ends 538, 540 of the rear wall 532 and extend outwardly therefrom. For example, each of the upper and lower lips 534, 536 may be provided in the form of a substantially rectangular panel oriented substantially perpendicularly with respect to the rear wall 532. One or more racetrack shaped openings 542 may extend through the rear wall 532 and may be spaced apart from one another between the first and second sides 528, 530 of the body 526 and between the opposing ends 538, 540 of the rear wall 532.

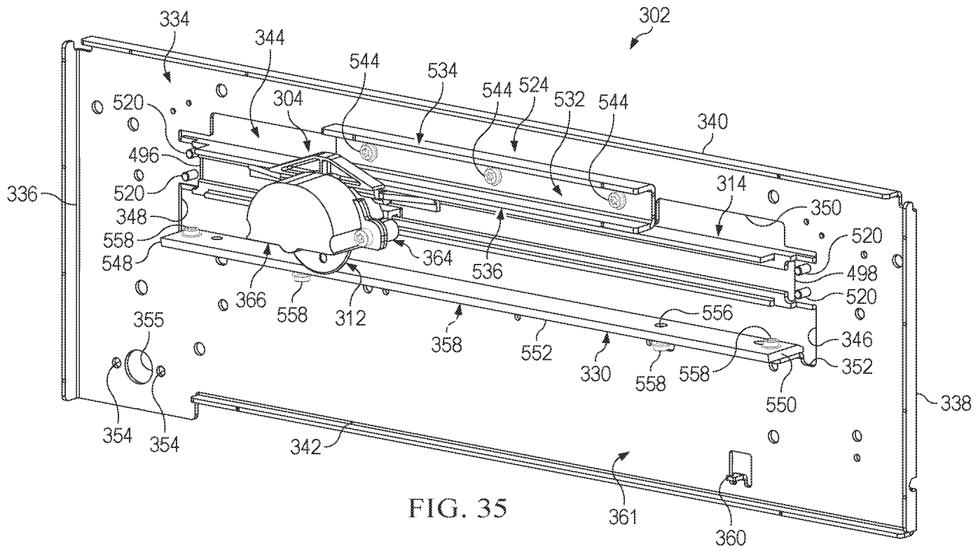

As best shown in FIG. 35, the support rail 524 may be coupled to the front face 361 of the frame 302 via one or more fasteners 544 and may be positioned adjacent to the top end 350 of the mouth 344. For example, the openings 542 of the rear wall 532 of the support rail 524 may be aligned with one or more mounting holes 354 proximate to the top end 350 of the mouth 344. Thus, the fasteners 544 may extend through each of the rear wall 532 of the support rail 524 and the frame 302 and may be securely received by one or both of the openings 542 and the mounting holes 354 (e.g., via engagement between complementary threaded surfaces thereof, via a press fit, or via any other suitable mechanism known in the art). The fasteners 544 may be provided in the same form as or a different form as compared to the fasteners 520 used to couple the guiderail 314 and the frame 302. In some instances, the support rail 524 may be positioned centrally with respect to the first and second sides 346, 348 of the mouth 344 and extend at least partially linearly therebetween. The lower lip 536 of the support rail 524 may be adjacent to or may directly abut the upper lip 508 of the guiderail 314.

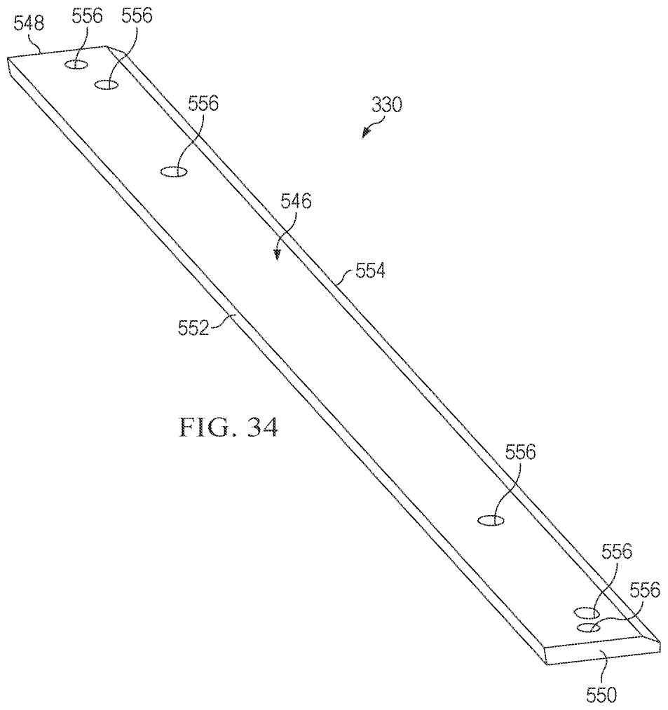

Turning to FIG. 34, the breaker bar 330 may be provided in the form of a rectilinear body 546 defined by a first side 548 and a second side 550 opposite the first side 548. The body 546 may include a beveled edge 552 and a rear edge 554 each extending linearly between the first and second sides 548, 550. One or more openings 556 may extend through the body 546 and may be disposed along the body 546 between the first and second sides 548, 550. In some instances, the breaker bar 330 may configured to be coupled to and/or supported by the shelf 358 of the frame 302. The breaker bar 330 may be oriented substantially parallel with respect to the guiderail 314 when the cutter assembly 300 is assembled. In some instances, the breaker bar 330 may be provided in the form of stainless steel (e.g., 300 series stainless steel) with a nitride treatment. In other instances, the breaker bar 330 may be provided in the form of other classes or types of steel or other magnetic or non-magnetic metals. In yet other instances, the breaker bar 330 may further include ceramics, anodized aluminum, or any other material having a suitable hardness. The breaker bar 330 is preferably non-magnetic such that magnetic media may be printed on without the breaker bar 330 interfering with its passage through the printer (e.g., the printers 100, 160, 210, or any other suitable printing device). Additionally, in some instances, the breaker bar 330 may undergo a through hardening process designed to increase the hardness of the entire body 546 of the breaker bar 330. In other instances, the breaker bar 330 may receive any case hardening treatment or any other treatment (e.g., nitriding treatment, carburizing treatment, nitro-carburizing treatment, powder coating, and the like) known in the art to harden steel or other metals.

The breaker bar 330 may be imparted with a hardness greater than 40 Hardness Rockwell C (HRC). In some instances, the breaker bar 330 may be imparted with a hardness of about 40 HRC to about 80 HRC (or 40 HRC to 80 HRC), or from about 40 HRC to about 60 HRC (or 40 HRC to 60 HRC). For example, the breaker bar 330 may be imparted with a hardness of at least about 40 HRC (or at least 40 HRC), or at least about 50 HRC (or at least 50 HRC), or at least about 60 HRC (or at least 60 HRC), or at least about 70 HRC (or at least 70 HRC), or at least about 80 HRC (or at least 80 HRC). In some instances, the breaker bar 330 may be imparted with a hardness of about 50 HRC (or 50 HRC). In some instances, the blade 312 may be imparted with a hardness that is substantially equal to the hardness of the breaker bar 330.

Referring again to FIG. 35, the breaker bar 330 may be positioned on the shelf 358 of the frame 302 and may be coupled thereto via one or more fasteners 558. For example, the openings 556 disposed along the body 546 of the breaker bar 330 may be aligned with one or more mounting holes 354 disposed along the shelf 358 of the frame 302. Thus, the fasteners 558 may extend through each of the body 546 of the breaker bar 330 and the shelf 358 of the frame 302 and may be securely received by one or both of the openings 556 and the mounting holes 354 (e.g., via engagement between complementary threaded surfaces thereof, via a press fit, or via any other suitable mechanism known in the art). At least a portion of the breaker bar 330 including the beveled edge 552 may extend beyond the shelf 358 of the frame 302.

As best shown in FIG. 36, the blade 312 may be oriented at a first angle A₁ with respect to the beveled edge 552 of the breaker bar. The first angle A₁ may be imparted with a value of about 0.5° to about 5° (or 0.5° to) 5°, or from about 0.5° to about 3° (or 0.5° to 3°), or from about 1° to about 2° (or 1° to 2°), or from about 1.5° to about 2° (or 1.5° to 2°), or from about 1° to about 1.5° (or 1° to) 1.5°. For example, the first angle A₁ may be imparted with a value of at least about 0.5° (or at least) 0.5°, or at least about 1° (or at least 1°), or at least about 1.5° (or at least) 1.5°, or at least about 2° (or at least) 2°, or at least about 2.5° (or at least) 2.5°, or at least about 3° (or at least 3°), or at least about 3.5° (or at least) 3.5°, or at least about 4° (or at least 4°), or at least about 4.5° (or at least) 4.5°, or at least about 5° (or at least) 5°. In some instances, the first angle A₁ may be imparted with a value of about 1.5° (or) 1.5°.

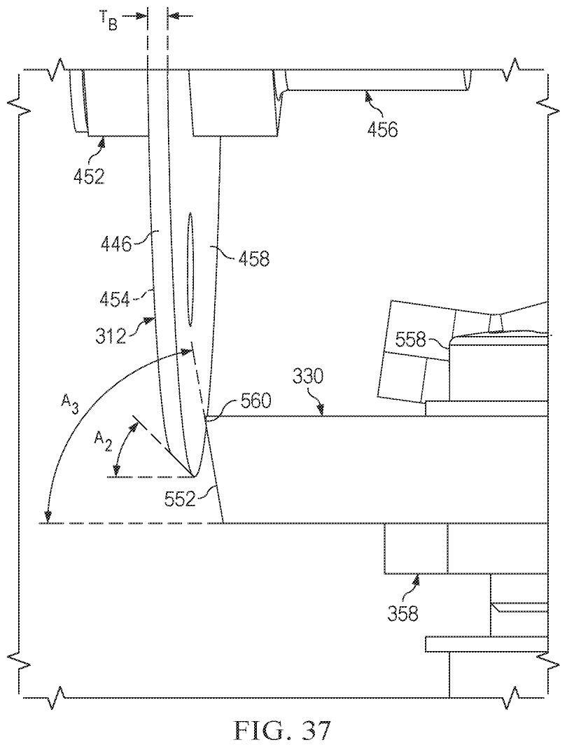

Turning to FIG. 37, the cutting edge 446 of the blade 312 may be defined by a second angle A₂. The second angle A₂ may be imparted with a value of about 10° to about 90° (or 10° to) 90°, or from about 20° to about 80° (or 20° to) 80°, or from about 30° to about 70° (or 30° to) 70°, or from about 40° to about 60° (or 40° to) 60°, or from about 30° to about 45° (or 30° to) 45°, or from about 45° to about 60° (or from 45° to) 60°. For example, the second angle A₂ may be imparted with a value of at least about 10° (or at least) 10°, or at least about 20° (or at least) 20°, or at least about 30° (or at least) 30°, or at least about 40° (or at least) 40°, or at least about 50° (or at least) 50°, or at least about 60° (or at least) 60°, or at least about 70° (or at least) 70°, or at least about 80° (or at least) 80°, or at least about 90° (or at least) 90°. In some instances, the second angle A₂ may be imparted with a value of about 45° (or) 45°. In some instances, the second angle A₂ may be imparted with a value of from 40° to 50°.

The beveled edge 552 of the breaker bar 330 may be defined by a third angle A₃. The third angle A₃ may be imparted with a value of about 25° to about 90° (or 25° to) 90°, or from about 30° to about 90° (or 30° to) 90°, or from about 40° to about 90° (or 40° to) 90°, or from about 50° to about 90° (or 50° to) 90°, or from about 60° to about 90° (or 60° to) 90°, or from about 70° to about 90° (or 70° to) 90°, or from about 80° to about 90° (or 80° to) 90°, or from about 70° to about 80° (or 70° to) 80°. For example, the third angle A₃ may be imparted with a value of at least about 25° (or at least) 25°, or at least about 40° (or at least) 40°, or at least about 50° (or at least) 50°, or at least about 60° (or at least) 60°, or at least about 70° (or at least) 70°, or at least about 80° (or at least 80°), or at least about 90° (or at least) 90°. In some instances, the third angle A₃ may be imparted with a value of about 80° (or) 80°. In some instances, the third angle A₃ may be imparted with a value of from 75° to 80°.

In some instances, (i) the first angle A₁ may be imparted with a value of from 0.5° to 5°, or from 0.5° to 3°, or from 1° to 2°, or from 1.5° to 2°, or from 1° to 1.5°, or of 1.5°; (ii) second angle A₂ may be imparted with a value of from 10° to 90°, or from 20° to 80°, or from 30° to 70°, or from 40° to 60°, or from 30° to 45°, or from 45° to 60°, or from 40° to 50°, or of 45°; and (iii) the third angle A₃ may be imparted with a value of from 25° to 90°, or from 30° to 90°, or from 40° to 90°, or from 50° to 90°, or from 60° to 90°, or from 70° to 90°, or from 80° to 90°, or from 70° to 80°, or from 75° to 80, or of 80°. In some instances, (i) the breaker bar 330 may be imparted with a hardness of from 40 HRC to 80 HRC, or from 40 HRC to 60 HRC, or of 50 HRC; and (ii) the blade 312 may be imparted with a hardness of from 40 HRC to 80 HRC, or from 40 HRC to 60 HRC, or of 50 HRC. In some instances, the breaker bar 330 is a non-magnetic breaker bar.

Thus, the beveled edge 552 of the breaker bar 330 may be configured to provide a single point of contact 560 with the blade 312 as the blade subassembly 304 moves laterally along the guiderail 314. The single point of contact 560 aids the operation of the cutter assembly 300 by creating a high stress point in the material being cut. In instances where the blade 312 may be susceptible to build up (e.g., an accumulation of adhesive material as a result of cutting, for example, adhesive labels), the angle A₁, the angle A₂, the angle A₃, and/or the single point of contact 560 may reduce the amount of build up over the life span of the cutter assembly 300.

As best shown in FIG. 37, the blade 312 may be defined by a thickness TB measured linearly between the first and second sides 454, 458 of the blade 312. In some instances, the thickness TB may be imparted with a value of about 0.2 mm to about 1 mm (or 0.2 mm to 1 mm), or from about 0.2 mm to about 0.8 mm (or 0.2 mm to 0.8 mm). For example, the thickness TB may be imparted with a value of at least about 0.2 mm (or at least 0.2 mm), or at least about 0.3 mm (or at least 0.3 mm), or at least about 0.4 mm (or at least 0.4 mm), or at least about 0.5 mm (or at least 0.5 mm), or at least about 0.6 mm (or at least 0.6 mm), or at least about 0.7 mm (or at least 0.7 mm), or at least about 0.8 mm (or at least 0.8 mm), or at least about 0.9 mm (or at least 0.9 mm), or at least about 1 mm (or at least 1 mm). In some instances, the thickness TB may be imparted with a value of 0.5 mm.

In some instances, the blade 312 (i) diameter DB may be imparted with a value of from 12 mm to 30 mm, or from 20 mm to 30 mm, or of 25.4 mm; and (ii) thickness TB may be imparted with a value of from 0.2 mm to 1 mm, or from 0.2 mm to 0.8 mm, or of 0.5 mm. In some instances, (i) the DB/LH ratio is from 0.4 to 6, or from 0.4 to 2.4, or from 0.4 to less than 2.0, or from 0.4 to 1.9, or from 1 to 1.9, or from 1.5 to 1.9, or from 1.8 to 1.9, or of 1.9; and (ii) the DB/LR ratio is from 0.3 to 3, or from 0.3 to 2, or from 0.3 to less than 2.0, or from 0.3 to 1.9, or from 0.75 to 1.9, or from 1 to 1.9, or from 1 to 1.5, or from 1 to 1.3, or from 1.2 to 1.3, or of 1.3.

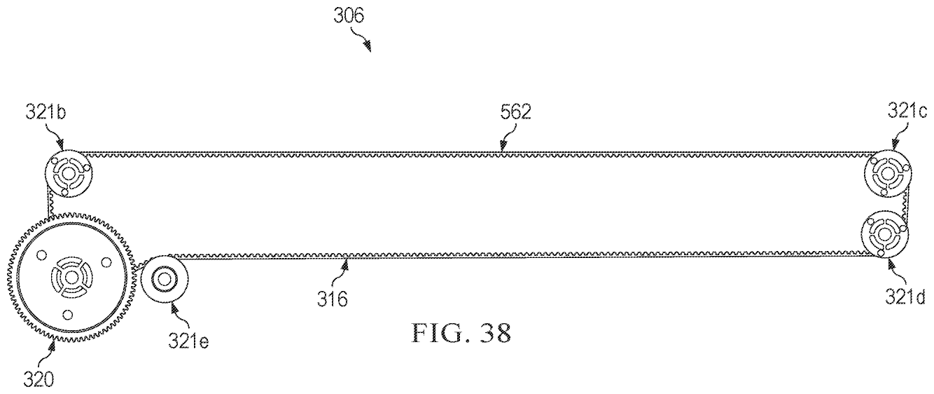

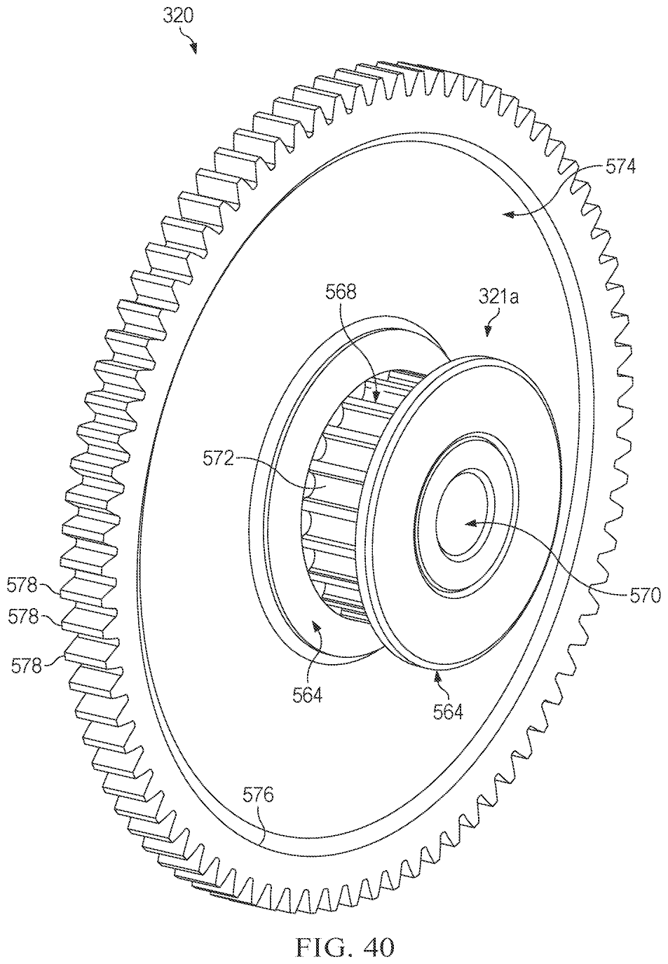

Turning now to FIG. 38, the pulley subassembly 306 may be designed to generate translational motion of the blade subassembly 304 along the guiderail 314. The belt 316 may surround and engage the plurality of pulleys 321. In some instances, the pulley subassembly 306 may include five pulleys 321a-321e. In other instances, any number of pulleys 321 may be provided and may be configured in any suitable arrangement. In some instances, rotation of the compound gear 320 may cause rotation of a first pulley 321a connected thereto (see FIG. 40), which may in turn cause a responsive rotation of the pulleys 321b-321e. The carrier 364 may be coupled to an active portion 562 of the belt 316 located between the second and third pulleys 321b, 321c.

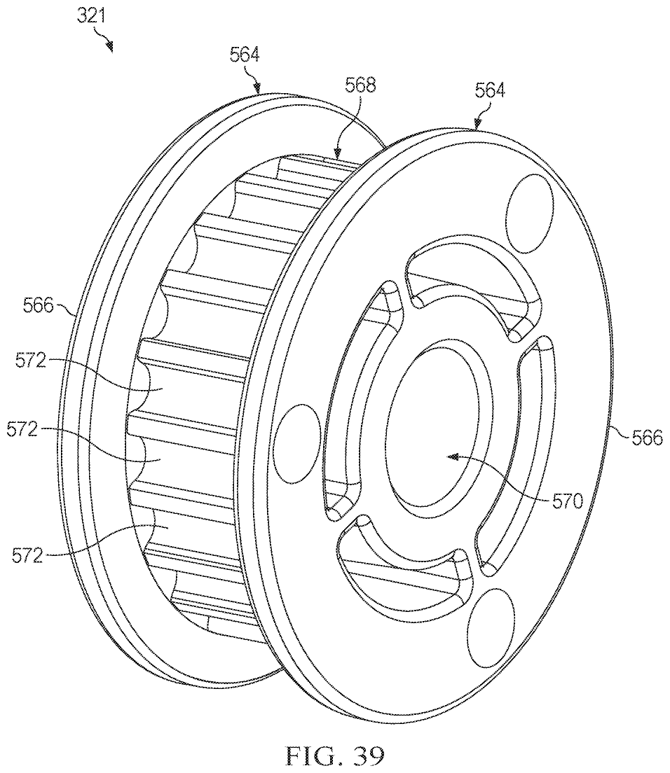

Turning to FIG. 39, each pulley 321 may be provided in the form of a two opposing substantially annular flanges 564, each defined by an outer perimeter 566, and a substantially annular notched wheel 568 disposed therebetween. The flanges 564 and the notched wheel 568 may be coaxial with respect to one another such that a substantially cylindrical opening 570 may extend therethrough. A plurality of notches 572 configured to receive or otherwise engage the belt 316 (e.g., provided in substantially the same form or a complementary form as the notches 414 of the carrier 364) may circumscribe the notched wheel 568 and may be evenly radially spaced apart from one another. Thus, each pulley 321 may be configured to convert rotational motion of the pulley 321 into translational or linear motion of the belt 316. In some instances, each of the five pulleys 321a-321e may be imparted with the aforementioned structure. In other instances, the pulley subassembly 306 may include any number of pulleys 321 having any suitable shape or structure, provided that the pulleys 321 are configured to drive motion of the belt 316.

As shown in FIG. 40, the compound gear 320 may be provided in the form of a substantially circular body 574 defined by an outer perimeter 576. A first plurality of teeth 578 may circumscribe the outer perimeter 576 and may be spaced evenly radially apart from one another. The first pulley 321a may be connected to the body 574 of the compound gear 320 and extend outwardly therefrom. The first pulley 321a may be formed integrally with the body 574 or may be coupled thereto. The first pulley 321a and the body 574 may be coaxial with respect to one another such that the opening 570 may extend entirely through both the compound gear 320 and the first pulley 321a. In some instances, the compound gear 320 may be configured to increase the gear ratio from the motor 322 to the pulleys 321a-321e.

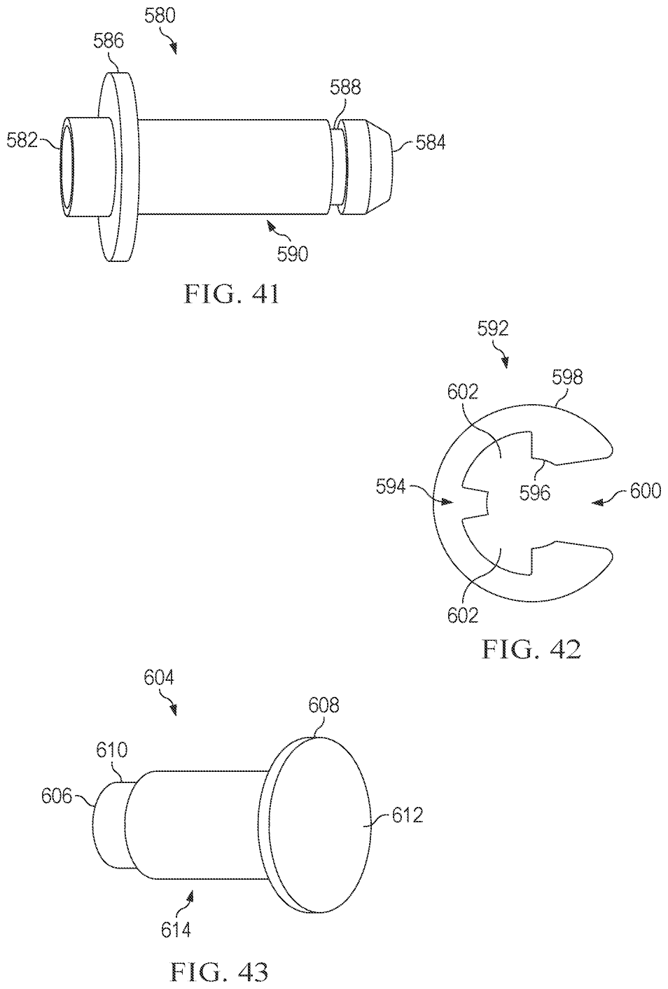

Turning to FIG. 41, a frame pin 580 designed to couple one or more of the pulleys 321 to the frame 302 may be provided in the form of a substantially tubular body defined by a first end 582 and a second end 584 opposing the first end 582. The frame pin 580 may include a disk member 586 proximate to the first end 582 and an annular groove 588 proximate to the second end 584. A mounting region 590 configured to receive the pulley 321 may be disposed between the disk member 586 and the groove 588. In some instances, the mounting region 590 may be imparted with substantially the same dimensions as the opening 570 of the pulleys 321.

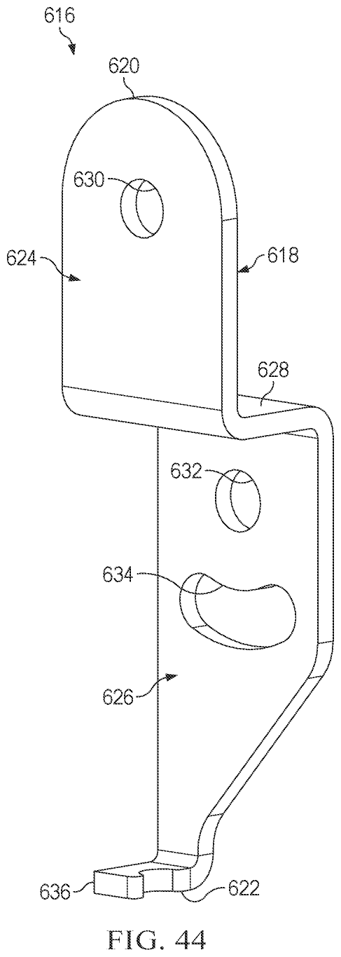

As best shown in FIG. 42, a washer 592 designed to reduce or more evenly distribute stress applied to the pulley 321 or other component of the pulley subassembly 306 may be provided in the form of a substantially annular disk 594 defined by an inner diameter 596 and an outer diameter 598. An entrance slot 600 via which the washer 592 may be installed on the groove 588 may be provided in the form of an opening extending between a portion of the inner diameter 596 and an adjacent portion of the outer diameter 598. Additionally, the washer 592 may include one or more flared cutouts 602 disposed along the inner diameter 596 and extending partially between the inner diameter 596 and the outer diameter 598.

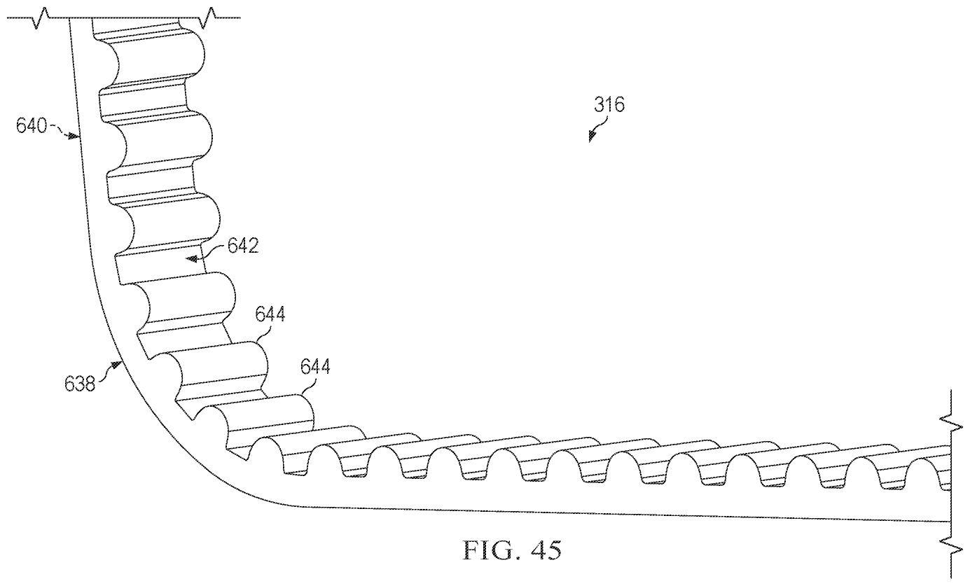

Turning to FIG. 43, a tensioner pin 604 designed to couple one or more of the pulleys 321 to the frame 302 may be provided in the form of a substantially tubular body defined by a first end 606 and a second end 608 opposing the first end 606. The tensioner pin 604 may include a cylindrical insert 610 at the first end 606, a circular button 612 at the second end 608, and a mounting region 614 configured to receive the pulley 321 disposed therebetween. In some instances, the mounting region 614 may be imparted with substantially the same dimensions as the opening 570 of the pulleys 321.

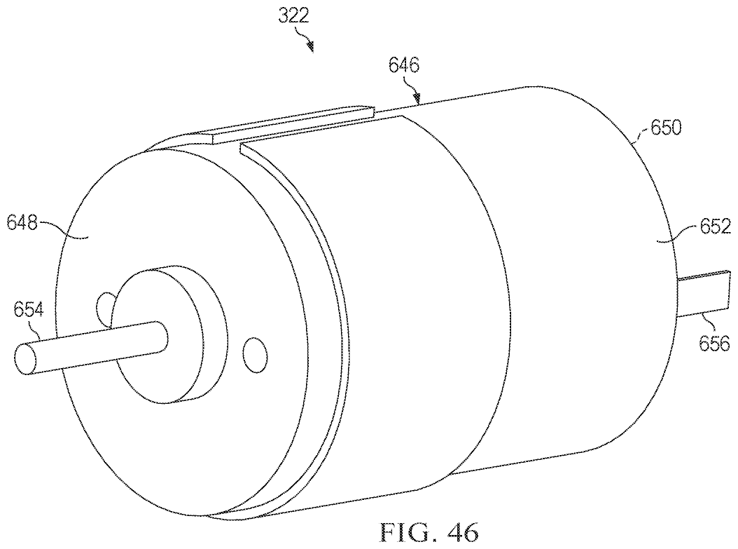

Now turning to FIG. 44, a belt tensioner 616 configured to facilitate mounting one or more pulleys 321 on the frame 302 may be provided in the form of a body 618 defined by a top end 620 and a bottom end 622. The body 618 may include an upper segment 624 proximate to the top end 620, a lower segment 626 proximate to the bottom end 622, and a connector 628 extending therebetween (e.g., coupling or connecting the upper and lower segments 624, 626). The upper and lower segments 624, 626 may each be substantially vertical (e.g., parallel with respect to the body 334 of the frame 302) and the connector 628 may extend substantially perpendicularly with respect to the upper and lower segments 624, 626. The upper segment 624 may include a pulley hole 630 configured to receive the insert 610 of the tensioner pin 604 and positioned proximate to the top end 620. The lower segment 626 may include a mounting hole 632 proximate to the connector 628 and a curved opening 634 positioned between the mounting hole 632 and the bottom end 622. The lower segment 626 may further include an anchor 636 positioned at the bottom end 622 and extending outwardly therefrom (e.g., in a direction substantially parallel to the connector 628).

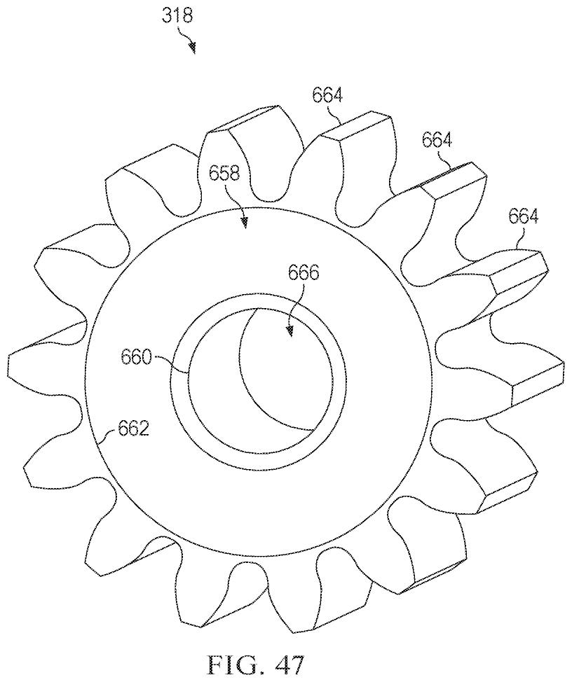

Turning to FIG. 45, the belt 316 may be provided in the form of an elongate body 638 defined by an exterior surface 640 and an interior surface 642. A plurality of rounded ridges 644 protrude upwardly from the interior surface 642 and are configured to be received by and/or one or more of the notches 414 of the carrier 364 and the notches 572 of the pulleys 321. The ridges 644 may be disposed and evenly spaced from one another along the interior surface 642 of the belt 316. In some instances, the ridges 644 may be substantially semicylindrical in shape. However, in other instances, the ridges 644 may be imparted with any suitable shape or structure, provided that the ridges 644 are configured to engage the notches 414, 572.

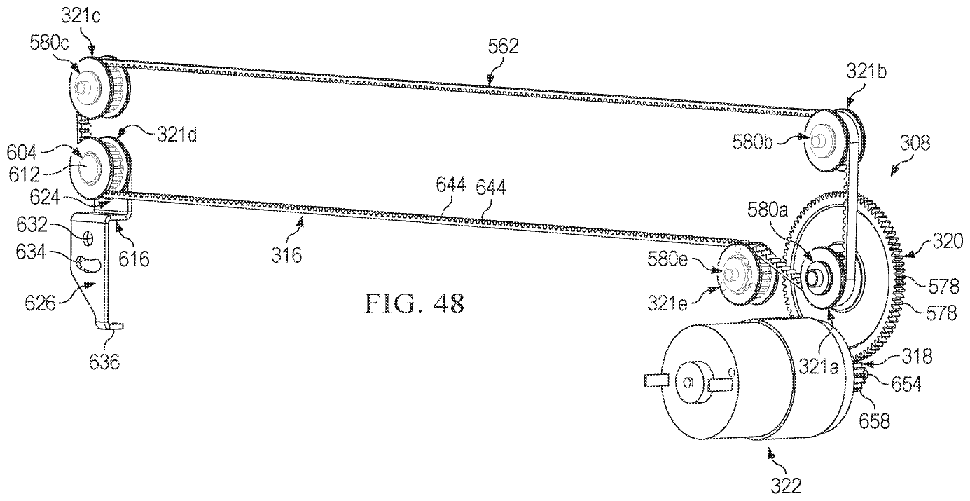

As best shown in FIG. 46, the motor 322 may be provided in the form of a substantially cylindrical body 646 having a front side 648, a back side 650 opposing the front side 648, and a substantially cylindrical sidewall 652 extending therebetween. A cylindrical pin member 654 protrudes outwardly from the front side 648 of the motor 322 and may be connected to or in communication with the motor 322. In some instances, the motor 322 may be configured to drive rotation of the pin member 654. The motor 322 may further include one or more contacts 656 configured to connect the motor 322 to an external power source (not shown) disposed on the back side 650 and extend outwardly therefrom. In some instances, the motor 322 may be provided in the form of a standard direct current (DC) motor. In other instances, the motor 322 may be provided in the form of an alternating current (AC) motor, a stepper motor, a servo motor, or any other suitable device.

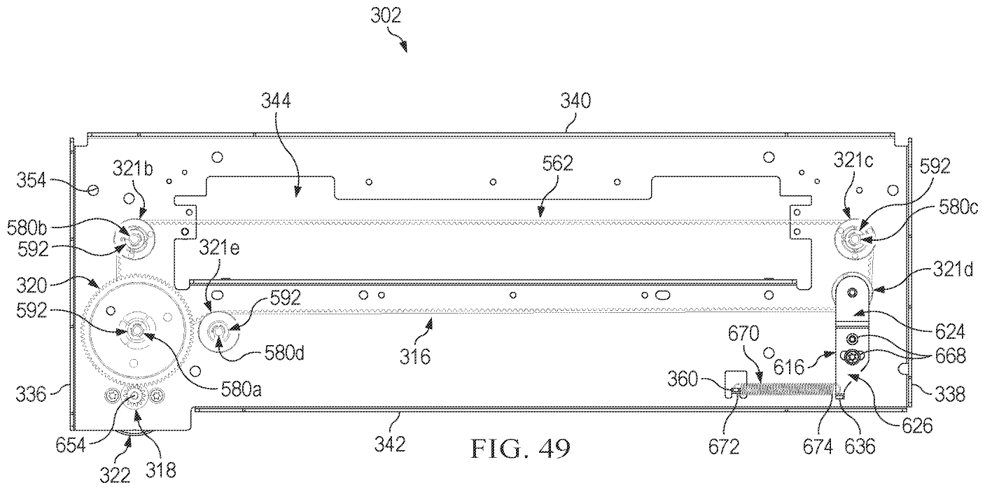

Turning to FIG. 47, the driving gear 318 may be provided in the form of an annular body 658 defined by an inner diameter 660 and an outer diameter 662. A second plurality of teeth 664 extend outwardly from the body 658 and may be disposed evenly radially about the outer diameter 662. The second plurality of teeth 664 may be configured to engage the first plurality of teeth of the compound gear 320. The inner diameter 660 may define a cylindrical opening 666 therethrough, which may be configured to receive the pin member 654 of the motor 322.

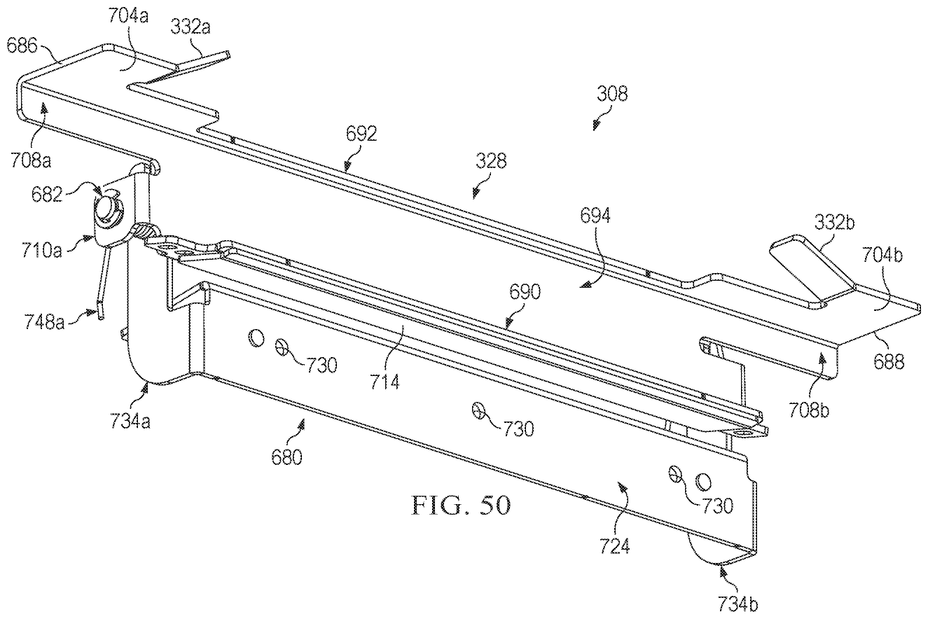

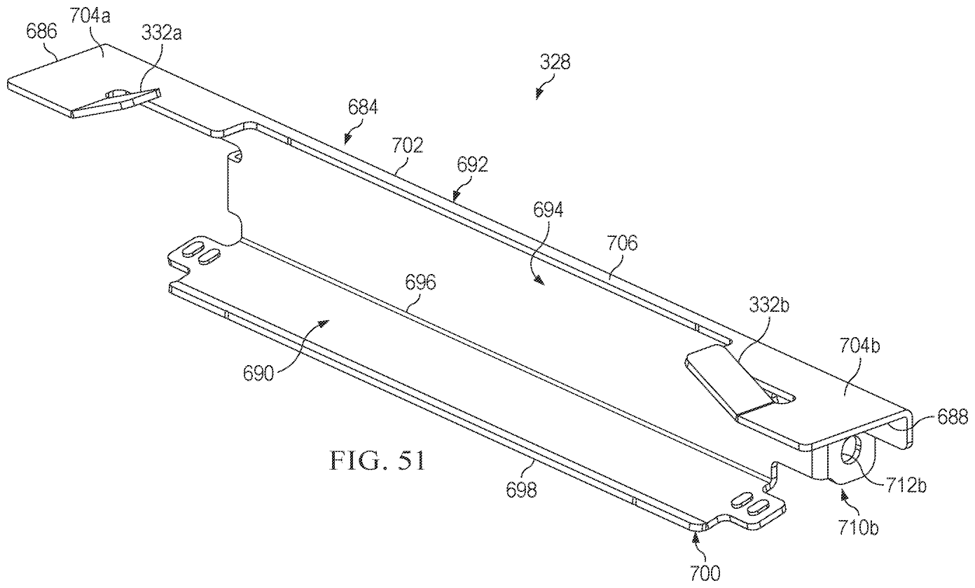

The pulley subassembly 306 may be arranged for installation on the frame 302 as shown in FIGS. 48 and 49. The mounting region 590 of a first frame pin 580a may be retained within the opening 570 extending through the compound gear 320 and the first pulley 321a. The first end 582 of the first frame pin 580a may extend outwardly from the first pulley 321a and be configured to be received by one of the mounting holes 354 of the frame 302, thereby coupling the compound gear 320 and the first pulley 321a to the frame 302 (see FIG. 49). The second, third, and fifth pulleys 321b, 321c, 321e may each receive a second, third, and fourth frame pin 580b, 580c, 580e, respectively. The second, third, and fourth frame pins 580b, 580c, 580e may facilitate coupling between the second, third, and fifth pulleys 321b, 321c, 321e and the frame 302 in the same manner as the first frame pin 580a. The mounting region 614 of the tensioner pin 604 may be received by the opening 570 of the fourth pulley 321d. The insert 610 of the tensioner pin 604 may be received by the pulley hole 630 of the belt tensioner 616 such that the fourth pulley 321d is retained between the button 612 of the tensioner pin 604 and the upper segment 624 of the belt tensioner 616.

The belt 316 may encircle one or more of the pulleys 321 such that the ridges 644 of the belt 316 engage the notches 572 of the pulleys 321. In some instances, the belt 316 may be configured such that the fifth pulley 321e engages the exterior surface 640 rather than the ridges 644 of the interior surface 642 of the belt 316. In this way, the fifth pulley 321e may be configured to cause an outward turn (e.g., clockwise from the perspective of FIG. 48) of the belt 316, whereas the first, second, third, and fourth pulleys 321a-321d may each be configured to cause an inward turn (e.g., counterclockwise from the perspective of FIG. 37) of the belt 316. Thus, the fifth pulley 321e may be arranged to deflect the belt 316 such that the first pulley 321 can engage the belt 316 rather than directly drive movement of the belt 316.

In some instances, the motor 322 may be positioned proximate to the compound gear 320 such that the pin member 654 is positioned adjacent to the first plurality of teeth 578 of the compound gear 320 and extends in a direction substantially parallel to the common rotational axis of the compound gear 320 and the first pulley 321a. The driving gear 318 may receive the pin member 654 of the motor 322 via the opening 666 and may be coupled thereto (e.g., via an adhesive agent, a press fit, or any other suitable mechanism known in the art) such that the pin member 654 and the driving gear 318 are configured to rotate in unison. The second plurality of teeth 664 of the driving gear 318 may be received by and engage the first plurality of teeth 578 of the compound gear 320. Thus, the motor 322 may be configured to drive rotation of the driving gear, thereby causing rotation of the compound gear 320 and movement of the belt 316 about the pulleys 321a, 321b, 321c, 321d. The motor 322 may be configured to generate bidirectional rotation of the pin member 654. Therefore, the motor 322 may be configured to drive motion of the belt 316 in either a first direction or a second direction opposite the first direction.

In other instances, the driving gear 318 and the compound gear 320 may be omitted. In those instances, the motor 322 may be configured to engage the pulleys 321 directly. For example, the motor 322 may be configured such that the pin member 654 is received by and configured to cause bidirectional rotation of the first pulley 321a rather than the driving gear 318. Alternatively, the motor 322 may be configured in any other suitable way, provided that the motor 322 is configured to generate bidirectional rotation of at least one pulley 321. Thus, the motor 322 may be arranged to drive movement of the belt 316 about the plurality of pulleys 321 without the use of gears.

As best shown in FIG. 49, a washer 592 may be installed in the grooves 588 of the first, second, third, and fourth frame pins 580a-580d. The belt tensioner 616 may be coupled to the frame 302 via a fastener 668 extending through the mounting hole 632 of the belt tensioner 616 and an adjacent mounting hole 354 of the frame 302. Another fastener 668 may extend through the curved opening 634 of the belt tensioner 616 and an adjacent mounting hole 354 of the frame 302, thereby coupling the lower segment 626 of the belt tensioner 616 to the frame 302. In some instances, the fit between the fastener 668 and the curved opening 634 may provide the belt tensioner 616 with some positional flexibility (e.g., capacity for translational or rotational movement with respect to the frame 302). Additionally, the belt tensioner 616 may be configured to impart the belt 316 with a desired tension (e.g., to supply a tension per the recommendations of the manufacturer of the belt 316).

A spring 670 configured to apply a force to the belt tensioner 616 may include a spiral-shaped body having a first end 672 and a second end 674. The first end 672 of the spring 670 may be coupled to the anchor 360 of the frame 302 and the second end 674 of the spring 670 may be coupled to the anchor 636 of the belt tensioner 616. The spring 670 may be imparted with a tension which may in turn apply a linear force to the lower segment 626 of the belt tensioner 616 in the direction of the first side 336 of the frame 302. In this way, the spring 670 may be configured to cause rotation of the belt tensioner 616 about the mounting hole 632. In some instances, the spring 670 may be provided to supply the pulley subassembly 306 with an initial tension. However, once the belt tensioner 616 is coupled to the frame 302 via a fastener 668 inserted through the mounting hole 632, the tension provided by the spring 670 may longer be necessary and the belt tensioner 616 may exclusively supply tension to the pulley subassembly 306.

The blade subassembly 304 may be installed along the active portion 562 of the belt 316 and be configured for translational movement between the second and third pulleys 321b, 321c. The active portion 562 may be disposed within the gap 379 between the angular members 374a, 374b of the runner 372. Thus, the notches 414 of the notched surface 415 disposed on the second angular member 374 may receive and engage the ridges 644 of the active portion 562 of the belt 316. In this way, linear motion of the belt 316 driven by the motor 322 may cause translational motion of the carriage 310, and thus the blade 312, along the guiderail 314 (see FIG. 35).

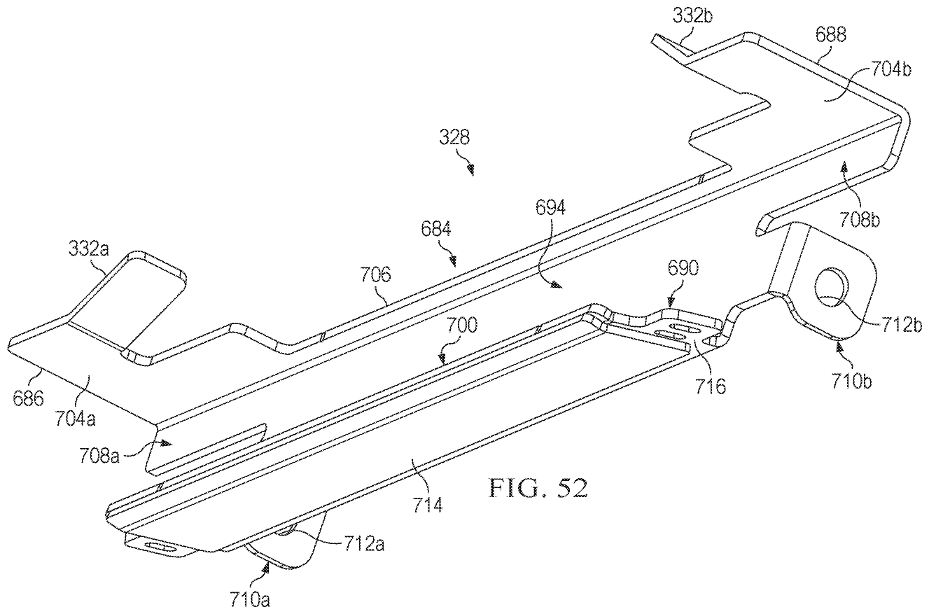

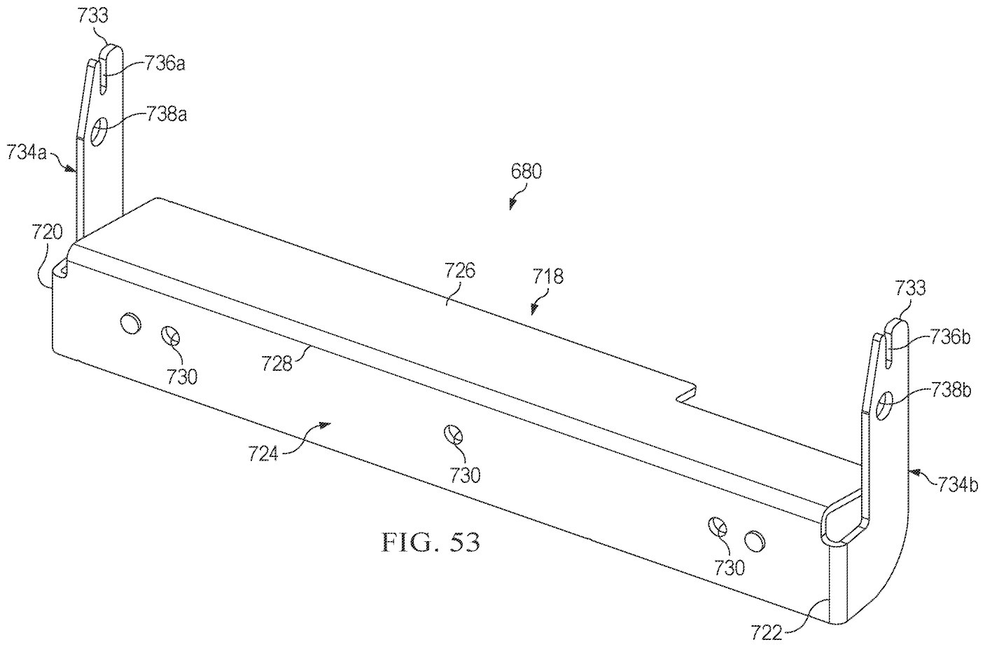

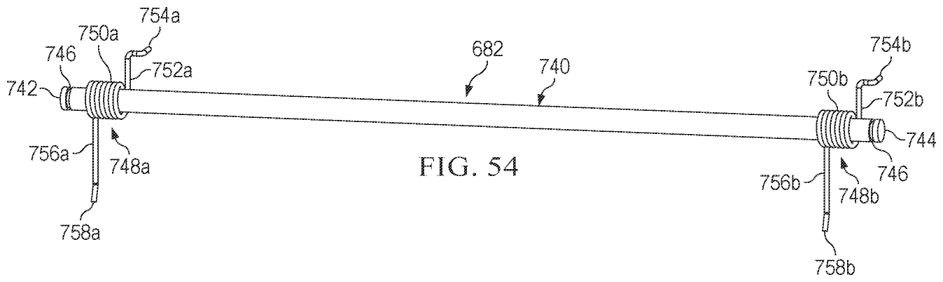

Now turning to FIG. 50, the clamping subassembly 308 may be provided in the form of a clamp 328 and a brace 680 flexibly coupled to the clamp 328 via a substantially cylindrical shaft 682. As best shown in FIGS. 51 and 52, the clamp 328 may be provided in the form of a substantially rectilinear body 684 defined by a first end 686 and a second end 688 opposing the first end 686. The clamp 328 may be defined by a lower shelf 690, an upper shelf 692 including the deflection tabs 332a, 332b, and a substantially rectilinear panel 694 extending therebetween. The lower shelf 690 may extend outwardly from a bottom edge 696 of the panel 694 and may terminate at a distal end 698 of the lower shelf 690. The lower shelf 690 may be oriented at a downward angle with respect to the panel 694 and may include a lip 700 disposed along the distal end 698 and extending at an upward angle therefrom with respect to the lower shelf 690. In some instances, the lip 700 may be oriented substantially perpendicular with respect to the panel 694 and may constitute the portion of the clamp 328 that directly contacts the printable media when the cutter assembly 300 is in use.

The upper shelf 692 may extend from an upper edge 702 of the panel 694 and may include stepped regions 704a, 704b proximate to the first end 686 and second end 688, respectively, of the clamp 328. The stepped regions 704a, 704b may be provided in the form of rectilinear protrusions oriented substantially perpendicular with respect to the panel 694. Each of the stepped regions 704a, 704b may include the deflection tab 332a, 332b extending inwardly therefrom and oriented at an upward angle with respect to the stepped regions 704a, 704b (e.g., the deflection tab 332a may extend toward the second end 688 and be angled away from the lower shelf 690 and the deflection tab 332b may extend toward the first end 686 and be angled away from the lower shelf 690). A substantially rectangular connecting region 706 of the upper shelf 692 may extend linearly between the stepped regions 704a, 704b along the upper edge 702 of the panel 694.

The body 684 of the clamp 328 may be provided in the form of a metal, plastic, combination thereof, or other suitable composite materials. For example, the body 684 may be provided in the form of carbon steel, stainless steel, wrought iron, aluminum, copper, titanium, tin, polycarbonate (PC), acrylonitrile butadiene styrene (ABS), polyvinyl chloride (PVC), polyethylene terephthalate (PET), carbon fiber, fiberglass, or any other suitable material.

As best seen in FIG. 52, the panel 694 may include substantially rectangular extension regions 708a, 708b positioned adjacent to the stepped regions 704a, 704b, respectively, and oriented substantially perpendicularly thereto. The panel 694 may further include substantially square or rectangular connection tabs 710a, 710b disposed beneath the extension regions 708a, 708b, respectively, and extending rearwardly therefrom (e.g., extending in a direction opposite to the direction of extension of the stepped regions 704a, 704b). Each connection tab 710a, 710b may include a substantially circular, ovoid, or similarly rounded opening 712a, 712b extending entirely therethrough and configured to receive at least a portion of the shaft 682.

The clamp 328 may further include a friction member 714 coupled to an underside 716 of the lower shelf 690 and the lip 700 and arranged to directly contact the media fed through the cutter assembly 300. The friction member 714 may be provided in the form of a substantially rectangular strip of a material selected to provide a high coefficient of friction when in contact with the printable media being severed by the cutter assembly 300. In some instances, the friction member 714 may be provided in the form of a strip of rubber adhered or otherwise coupled to the underside 716 of the lower shelf 690 and the lip 700. In other instances, the friction member 714 may be provided in the form of foam, textured plastics, silicone, felt, microfiber, or any other suitable material.

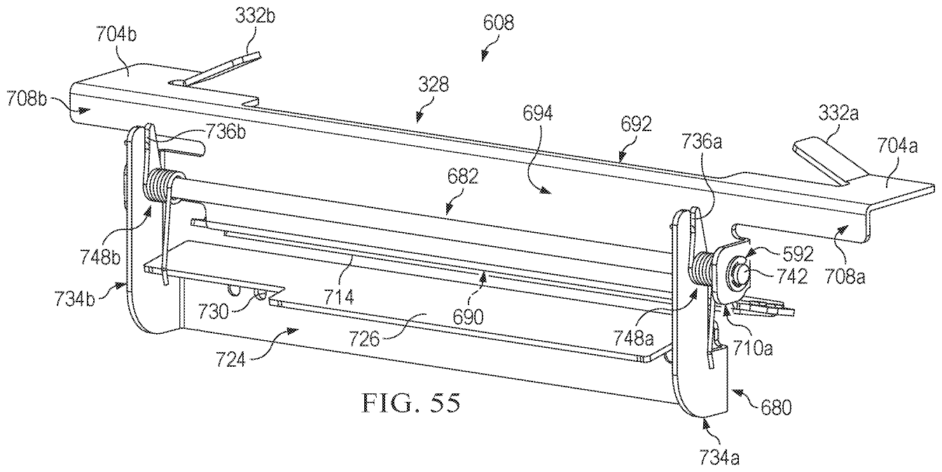

Turning to FIG. 53, the brace 680 may be provided in the form of a body 718 defined by a first side 720 and a second side 722. The body 718 may include a mounting plate 724 extending between the first and second sides 720, 722 and a rectilinear fin 726 extending rearwardly from an upper edge 728 of the mounting plate 724. One or more mounting holes 730 configured to align with one or more mounting holes 354 of the frame 302 may be disposed on the mounting plate 724 and may extend entirely therethrough. The brace 680 may further include connecting arms 734a, 734b connected to the mounting plate 724 at the first and second sides 720, 722, respectively, and extending rearwardly and upwardly therefrom and terminating at a distal end 733. Slots 736a, 736b provided in the form of a linear or substantially rectangular cutout or channel may be disposed at the distal end 733 of the connecting arms 734a, 734b and extend at least partially downwardly therefrom. The arms 734a, 734b may further include substantially circular openings 738a, 738b proximate to the slots 736a, 736b and arranged to align with the openings 712a, 712b, respectively, of the connection tabs 710a, 710b of the clamp 328. In some instances, the openings 738a, 738b may be imparted with substantially the same geometry as the shaft 682.

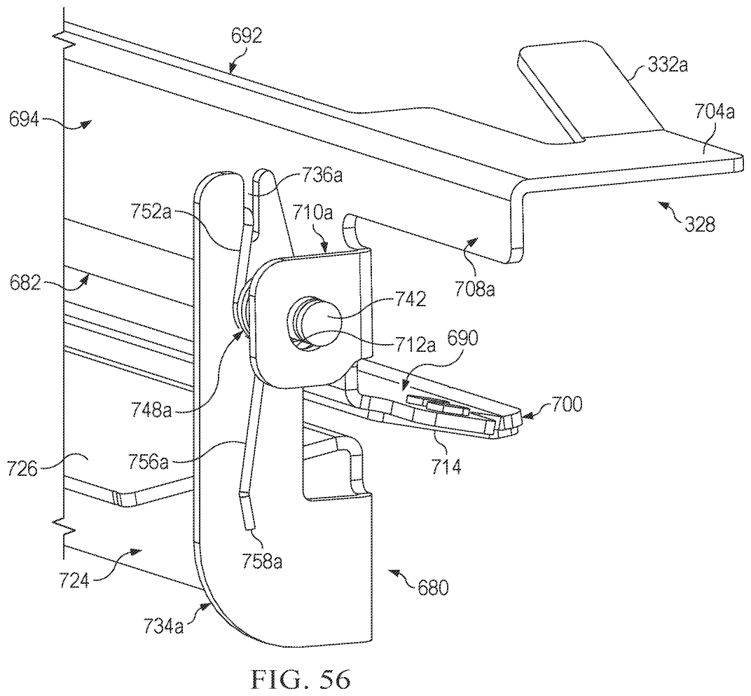

Turning to FIG. 54, the shaft 682 may be provided in the form of a substantially cylindrical body 740 defined by a first end 742 and a second end 744 opposing the first end 742. Circular grooves 746 may be disposed adjacent to each of the first and second ends 742, 744 and are each configured to receive the washer 592 (see FIG. 42). Two spring members 748a, 748b may be disposed along the shaft 682 proximate to the first and second ends 742, 744, respectively. The spring members 748a, 748b may each be provided in the form of a spiral body 750, an upper limb 752 extending upwardly from the spiral body 750 and terminating at a distal end 754 of the upper limb 752, and a lower limb 756 extending downwardly from the spiral body 750 and terminating at a distal end 758 of the lower limb 756.

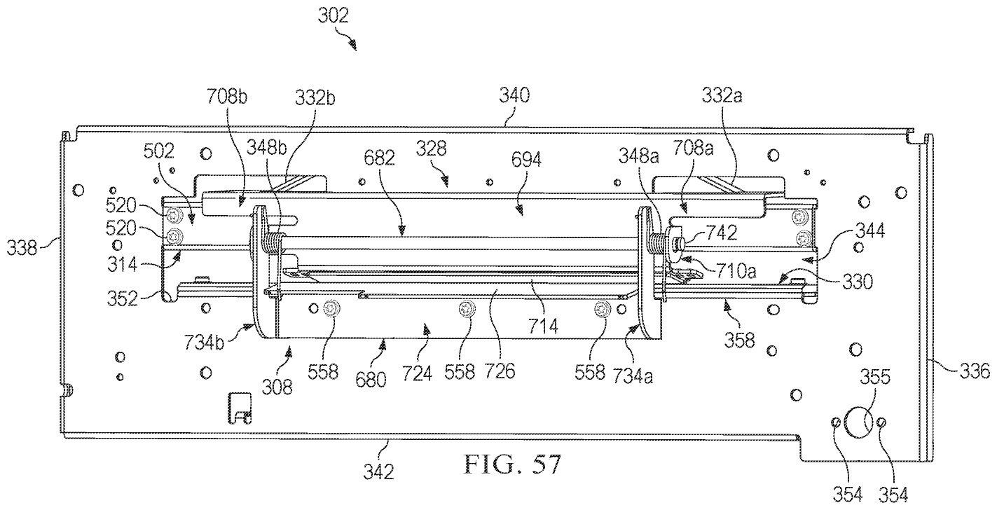

Turning to FIGS. 55 and 56, the clamp 328 and the brace 680 may be aligned such they may be coupled together via the shaft 682. For example, the opening 712a of the clamp 328 and the opening 738a of the brace 680 may receive the first end 742 of the shaft 682 and the opening 712b of the clamp 328 and the opening 738b of the brace 680 may receive the second end 744 of the shaft 682. The spring members 748a, 748b may be disposed along the shaft 682 and positioned adjacent to the arms 734a, 734b such that the distal ends 754a, 754b of the upper limbs 752a, 752b may be received by the slots 736a, 736b of the brace 680. In some instances, one or more of the distal ends 758a, 758b of the lower limbs 756a, 756b may be connected to another element of the clamping subassembly 308 (e.g., to the fin 726) or to an adjacent component of the printer within which the cutter assembly 300 is installed. Thus, the spring members 748a, 748b may be configured to apply a consistent downward force on the clamp 328. In some instances, washers 592 may be installed in the grooves 746 of the shaft 682 to, for example, prevent disassembly of or mitigate forces applied to the clamping subassembly 308.

As best shown in FIG. 56, the shaft 682 may be secured within the openings 738a, 738b of the brace 680, but the openings 712a, 712b of the clamp 328 may be configured such that the clamp 328 is capable of substantially vertical movement with respect to the brace 680. Thus, the carriage 310 may impact either of the deflection tabs 332a, 332b (as described above with reference to FIG. 10) and cause the clamp 328 to move upwards with respect to the brace 680 as permitted by the openings 712a, 712b. For example, the apex 400 of the carrier 364 may be configured to apply an upward pressure to the deflection tabs 332a, 332b as the carriage 310 approaches the first and second ends 496, 498, respectively, of the guiderail 314.

The consistent force applied to the clamp 328 by the spring members 748a, 748b may oppose the upward force applied by the carriage to the deflection tabs 332a, 332b. Thus, the spring members 748a, 748b may bias the clamp 328 against the upward movement caused by the carriage 310 and may cause the clamp 328 to return to a lowered position when the carriage 310 no longer contacts either of the deflection tabs 332a, 332b. Additionally, the force applied by the spring members 748a, 748b when the carriage 310 is not in contact with either of the deflection tabs 332a, 332b may increase the amount of friction applied by the friction member 714 to the printable media when the cutter assembly 300 is in use.

Similarly, the spring members 748a, 748b may be configured to initiate an automatic cleaning action of the blade 312 each time the carriage 310 impacts either of the deflection tabs 332a, 332b. In particular, the consistent downward force applied by the spring members 748a, 748b may cause motion of the carriage 310 relative to the breaker bar 330 when the carriage 310 engages one of the deflection tabs 332a, 332b. In some instances, the clamping subassembly 308 may be configured such that the spring members 748a, 748b may cause the carriage 310 (and thus the blade 312) to move substantially downwardly (e.g., away from the clamp 328) with respect to the beveled edge 552 of the breaker bar 330.

The relative motion between the blade 312 and the breaker bar 330 may cause the blade 312 to “wipe” or deposit any buildup (e.g., an accumulation of adhesive from severing one or more adhesive labels from a continuous supply thereof) that has been collected on the blade 312 onto the breaker bar 330. In this way, buildup may be deposited onto a region of the breaker bar 330 that is isolated from the cutting region (e.g., the region where the cutting edge 446 of the blade 312 contacts the beveled edge 552 of the breaker bar 330). Due to this operation, the clamping subassembly 308 may eliminate or reduce buildup on the blade 312 during use, thereby increasing the life span of the cutter assembly 300. In some instances, the clamping subassembly 308 may be configured to cause 0.2 mm or more of motion of the blade 312 relative to the breaker bar 330.

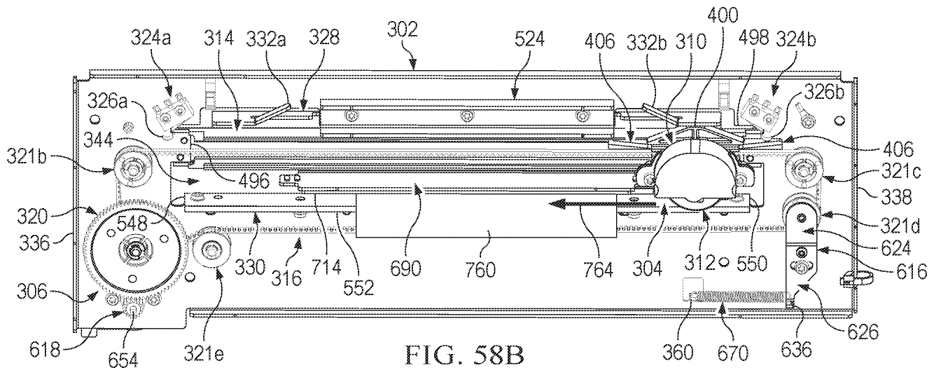

As best shown in FIG. 57, the brace 680 may be coupled to the frame 302 via one or more fasteners 558. The mounting plate 724 of the brace 680 may be positioned flush with the portion of the frame 302 proximate the bottom end 352 of the mouth 344 such that the mounting holes 730 of the brace 680 align with an equivalent number of mounting holes 354 of the frame 302. Thus, the fasteners 558 may extend through each of the brace 680 and the frame 302 and be securely received by one or both of the mounting holes 730 and the mounting holes 354 (e.g., via engagement between complementary threaded surfaces thereof, via a press fit, or via any other suitable mechanism known in the art). The clamp 328 may not be directly coupled to the frame 302 aside from its engagement with the brace 680 and the shaft 682. The extension regions 708a, 708b may be positioned adjacent to the rear wall 502 of the guiderail 314 and the friction member 714 may directly abut the breaker bar 330 when the clamping subassembly 308 is installed on the frame 302.

Turning to FIGS. 58A-58C, a method of severing a portion of printable media using the cutter assembly 300 is depicted. First, a desired portion 760 of a supply 762 of printable media is fed through the cutter assembly 300 via the mouth 344 (not shown). The blade subassembly 304 may occupy a default position (shown in FIGS. 58A and 58B) proximate to the second side 338 of the frame 302. The carrier 364 may be configured to engage the deflection tab 332b when the blade subassembly 304 is in the default position, thereby lifting the clamp 328. In this way, the friction member 714 may be retained at a distance from the breaker bar 330 and may be prevented from impeding the movement of the desired portion 760 of the printable media supply 762 through the mouth 344.

Second, the motor 322 may be activated and the pulley subassembly 306 may initiate a cutting step by causing the blade subassembly 304 to leave the default position and travel linearly across the guiderail 314 in the direction of the arrow 764 of FIG. 58B (e.g., toward the first end 548 of the breaker bar 330). As the carriage 310 leaves the second end 550 of the breaker bar 330, the carriage 310 may disengage the deflection tab 332b (e.g., the apex 400 may no longer contact the deflection tab 332b) and the clamping subassembly 308 may cause the clamp 328 to descend toward the breaker bar 330. In this way, the friction member 714 may contact the supply 762 of printable media and stabilize the supply 762 with respect to the breaker bar (e.g., to prevent movement of the supply and/or the desired portion 760 during cutting). The carriage 310 may carry the blade 312 from the second side 550 to the first side 548 of the breaker bar 330 along the beveled edge 552, thereby severing the desired portion 760 from the printable media supply 762.

The cutting step may terminate when the blade subassembly 304 approaches the first end 548 of the breaker bar 330 and at least a portion of the blade subassembly 304 (e.g., the appendage 406) contacts the trigger 326a and causes the switch 324a to deactivate the motor 322. Before the carriage 310 contacts the trigger 326a (or simultaneously therewith), the carriage 310 may engage the deflection tab 332a (e.g., via contact between the deflection tab 332a and the apex 400). Thus, the clamp 328 may be lifted away from the breaker bar 330 as the carriage 310 approaches the first end 548 of the breaker bar 330, thereby releasing the supply 762 of printable media. When the carriage reaches the first end 548 of the breaker bar 330, the desired portion 760 may be completely severed from the supply 762 of printable media and may, for example, be retrieved by a user.

At the same time, the clamp 328 may initiate the automatic cleaning action of the blade 312 (as described above with reference to FIG. 56) by applying a reciprocal downward force on the blade subassembly 304 when the carriage 310 engages and lifts the clamp 328. In instances where the supply 762 of printable media is provided in the form of, e.g., a strip of adhesive labels, the automatic cleaning action of the blade 312 may cause buildup of adhesive material from the cut to be transferred from the blade 312 to the breaker bar 330 where it may be unable or less likely to interfere with subsequent cuts.

Third, the printer (not shown) may retract the supply 762 of printable media at least partially into the printer (e.g., away from the mouth 344). Fourth, the pulley subassembly 306 may transport the blade subassembly 304 away from the first end 548 of the breaker bar 330 and back to the default position without impacting or otherwise being impeded by the supply 762 of printable media. The blade subassembly 304 may reach the default position when the carriage 310 contacts the trigger 326b, thereby causing the switch 324b to deactivate the motor 322 and terminate motion of the carriage 310. The blade 312 may undergo another automatic cleaning action initiated by contact between the carriage 310 and the deflection tab 332b upon the return of the blade subassembly 304 to the default position.

It will be appreciated by those skilled in the art that while the above disclosure has been described above in connection with particular embodiments and examples, the above disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference as if each such patent or publication were individually incorporated by reference herein. Various features and advantages of the above disclosure are set forth in the following claims.

1. A cutter assembly for use in a printer, comprising:
a carriage configured for translational movement along a guiderail having a first end and a second end;
a blade retained within the carriage;
a breaker bar extending along a path of motion of the blade;
a belt engaging at least a portion of the carriage;
one or more pulleys configured to facilitate motion of the belt; and
a clamp positioned to engage the carriage at one or both of the first end and the second end of the guiderail,
wherein engagement between the clamp and the carriage causes an automatic cleaning action of the blade.

2. The cutter assembly of claim 1, further comprising:
one or more gears configured to drive rotation of at least one of the one or more pulleys; and
a motor configured to drive rotation of at least one of the one or more gears.

3. The cutter assembly of claim 1, wherein the clamp further comprises one or more deflection tabs arranged to be engaged by the carriage at one or both of the first end and the second end.

4. The cutter assembly of claim 3, wherein engagement between the carriage and at least one of the one or more deflection tabs causes an upward motion of the clamp and releases a supply of printable media.

5. The cutter assembly of claim 3, wherein engagement between the carriage and at least one of the one or more deflection tabs causes the blade to deposit material buildup on the breaker bar.

6. The cutter assembly of claim 1, wherein the breaker bar further comprises a beveled edge arranged to contact the blade, and wherein the beveled edge is defined by an angle of between about 75° to about 85°.

7. The cutter assembly of claim 6, wherein a single point of contact exists between the beveled edge and the blade.

8. The cutter assembly of claim 1 further comprising a belt tensioner coupled to at least one of the pulleys and configured to provide tension to the belt.

9. The cutter assembly of claim 1, wherein a switch configured to terminate motion of the carriage is positioned proximate to at least one of the first end and the second end.

10. The cutter assembly of claim 1, wherein the clamp further comprises a friction member configured to restrict the movement of a supply of printable media when the carriage is in motion.

11. A cutter assembly for use in a printer, comprising:
(A) a frame;
(B) a blade subassembly supported by the frame, the blade subassembly comprising:
(i) a carriage arranged for translational motion across the frame; and
(ii) a blade retained within the carriage;
(C) a pulley subassembly supported by the frame and configured to generate translational motion of the blade subassembly, the pulley subassembly comprising:
(i) one or more pulleys; and
(ii) a belt connected to the carriage and arranged for linear motion around the one or more pulleys; and
(D) a clamping subassembly supported by the frame and configured to be engaged by the blade subassembly, the clamping subassembly comprising:
(i) a brace fixedly coupled to the frame;
(ii) a clamp flexibly coupled to the brace; and
(iii) one or more spring members configured to apply a downward pressure on the clamp.

12. The cutter assembly of claim 11, wherein the pulley subassembly includes five pulleys.

13. The cutter assembly of claim 11, further comprising a non-magnetic breaker bar extending along a path of motion of the blade.

14. The cutter assembly of claim 13, wherein the blade is oriented at an angle of about 1° to about 2° with respect to the non-magnetic breaker bar.

15. The cutter assembly of claim 11, wherein the blade includes a cutting edge defined by an angle of between about 40° to about 50°.

16. The cutter assembly of claim 11, further comprising a motor engaging one or more gears, wherein the motor is configured to drive rotation of the one or more gears, and wherein the one or more gears are configured to cause rotation of the one or more pulleys.

17. The cutter assembly of claim 16, further comprising at least one switch arranged to be engaged by the blade subassembly, wherein the at least one switch is configured to deactivate the motor when engaged by the blade subassembly.

18. The cutter assembly of claim 11, wherein the clamp is configured to release a portion of a printable media when the blade subassembly engages the clamping subassembly.

19. The cutter assembly of claim 11, wherein engagement between the blade subassembly and the clamping subassembly causes an automatic cleaning action of the blade.

20. A method of cutting a supply of media within a printer, comprising:
providing a cutter assembly having a frame supporting a blade subassembly, the blade subassembly occupying a default position and comprising a carriage and a blade retained by the carriage, a pulley subassembly comprising a belt coupled to the carriage and configured for linear movement about one or more pulleys, and a clamping subassembly configured to be releasably engaged by the carriage;
feeding the supply of media through a mouth of the frame such that a desired portion of the supply of media extends beyond a breaker bar coupled to the frame;
generating linear motion of the belt such that the carriage moves across the frame and the blade severs the supply of media along an edge of the breaker bar;
retracting the supply of media away from the mouth; and
returning the blade subassembly to the default position.
